(19) United States
(12) Patent Application Publication
(10) Pub. No.: US 2021/0368241 A1
(43) Pub. Date: Nov. 25, 2021

(54) SYSTEM AND METHOD FOR CURATING INTERNET MULTIMEDIA CONTENT FOR TELEVISION BROADCAST

(71) Applicant: KOSMAS GEORGE BALLIS, ATLANTIC BEACH, FL (US)

(72) Inventor: KOSMAS GEORGE BALLIS, ATLANTIC BEACH, FL (US)

(21) Appl. No.: 17/207,783

(22) Filed: Mar. 22, 2021

Related U.S. Application Data
(60) Provisional application No. 63/002,813, filed on Mar. 31, 2020.

(51) Int. Cl. H04N 21/475; H04N 21/472; H04N 21/45

(52) U.S. Cl. CPC H04N 21/4756; H04N 21/4532; H04N 21/472

(57) ABSTRACT

The problem of providing internet multimedia content for television broadcast is solved by a computer implemented method and system that includes a Mobile Application for viewing Snippets. Snippets can be provided by users of the Mobile App and voted on by other users of the Mobile App. Snippets that receive sufficient votes are categorized into a trending snippet category. App users can select the Trending Snippet Category to view the snippets therein. The Snippets in the trending category are also provided to a broadcast network that organizes the Snippets for television broadcast and provides a schedule for such broadcast. Users of the Mobile App can be provided access to the schedule so they can watch the television broadcast of the trending Snippets.

### CROSS-REFERENCE TO RELATED APPLICATION

This application claims the benefit of U.S. Provisional Application Ser. No. 63/002,813, filed Mar. 31, 2020, the disclosure of which is hereby incorporated by reference in its entirety, including all figures, tables, and drawings.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever. Copyright 2021©Kosmas Ballis.

### BACKGROUND OF INVENTION

Television networks have been losing viewership for decades with the rise of the internet and many other options available to consumers in today's fast-paced, technology-driven society. As a result, television revenue and programming have suffered, and internet-based companies have stepped up their game in the realms of streaming content. This makes it difficult for television networks to garner new viewers, particularly younger viewers well-acquainted with navigating the internet.

Television networks, like most media companies, rely on the sale of broadcast time “on air” or “air time” to advertisers, which is an antiquated business model that has not kept up with newer internet advertising models. Nonetheless, television networks are still able to charge advertisers considerably more for “air time” than can be garnered by internet companies, despite garnering a smaller audience. This will inevitably change as internet technology continues to evolve. The gap between internet content and television viewership needs to be bridged if television networks hope to remain relevant in the future. One option is to translate content on the internet into a format usable in television broadcasting. Ideally, such translation will operate to monetize both the internet content and the subsequent use in television broadcast.

### BRIEF SUMMARY

This Summary is provided to introduce a selection of concepts in a simplified form that are further described in the Detailed Description of the invention. This summary is not intended to identify key or essential inventive concepts of the claimed subject matter, nor is it intended for determining the scope of the claimed subject matter.

The computer-implemented method and system (CIMS) disclosed herein addresses the above stated need to bridge the gap between internet content and television programming. Embodiments of the CIMS of the subject invention include software or computer-implemented instructions stored on a server computer or server system that includes a Mobile Application module that can be acquired by and used with various types of client devices. The Mobile Application executed on a client device allows an App User to obtain and view multimedia content, such as, for example, audiovisual content or a “video.” An App User can use the Mobile App to view multimedia content that has been uploaded to memory storage accessible by the server computer or server system. The Mobile App can also be used to upload multimedia content created by an App User. An App user that uploads multimedia content is an Owner User of the multimedia content. Multimedia content can be of any length, from a few minutes to an hour or more. Preferably, multimedia content uploaded to the memory storage with the Mobile App is relatively short, for example, a “Snippet” one minute or less. The Mobile App can also allow the Owner User to perform one or more actions with regard to the uploaded multi-media content or “Owner Snippet,” including, for example, assigning the Owner Snippet to one or more categories, providing narrative descriptive information, and one word descriptors, or “tags”, for search purposes.

Once the Owner User has uploaded the Owner Snippet, the CIMS will associate one or more vote buttons therewith. The vote button provided can be, for example, based on the Category or other descriptive information that the Owner User provided with the Owner Snippet. Once uploaded, the Owner Snippet becomes a Snippet within a Snippet Library. App Users of the Mobile Application can select a Category, from a plurality of Categories, to view at least one Snippet assigned to, placed in, tagged, or otherwise associated with that Category. App Users can also search for one or more Snippets utilizing the identifying information or tags associated with each Snippet.

Snippets can be curated by App Users by submitting an opinion or vote on a Snippet. After viewing a Snippet, the one or more vote buttons associated with the Snippet can be used to submit a vote to the CIMS regarding the Snippet. A vote button can be made available before viewing a Snippet and after viewing a Snippet, so that it is not necessary to view a Snippet to vote. Various vote options can be provided. An App User can provide a positive vote or a negative vote or some variation there between. For example, if the User liked the Snippet, a “thumbs-up” or up-arrow vote button can be selected or “clicked” to submit that vote to the CIMS. Conversely, if the User did not like the Snippet, a “thumbs-down” or down-arrow button can be clicked to submit that vote to the CIMS. There can also be buttons for other opinions of the Snippet, such as was the Snippet informative or funny.

Snippets are curated when the CIMS received the votes and calculates a Tally for each of the types of votes receives from Users for each the Snippet. The Tally calculated for a Snippet can be compared with the Tally calculated for each other Snippet in a Snippet Library, both within a Snippet Category and from all categories. A pre-determined number of Snippets with the highest Tallies, or that are “trending” among App users, can be qualified for or assigned to a specific Trending Snippet Category reserved for the predetermined number of “Trending Snippets.” The Trending Snippets Category can be dynamic, such that the content can change periodically, e.g., hourly, daily, weekly, or can vary depending on a variety of factors, such as, but not limited to, the number of new Snippets added to the Snippet library, the votes received by the Snippets, viewership at any given time, etc. The content of the trending Snippets Category can also change depending on when Snippets obtain a Tally qualifying them eligible to move into the Trending Snippets Category and newly added Trending Snippets can displace other Snippets in the Trending Snippets Category that may have a lower Tally. The trending Snippets Category can contain only a certain number of Snippets and only a certain number of Snippets that have the highest Tallies or Rank at a certain time are included in the Trending Category. Alternatively, the Trending Category can comprise a certain percentage of the Snippets, selected from those Snippets having the highest Rank. For example, when Snippets in the Snippet Library are collated top Ranked 10% can be selected for the Trending Category, which may comprise 900 snippets. When the Snippet Library is collated again, the top 10% may comprise 1,100 Snippets. Another alternative is to include all Snippets in the Trending Category that have a minimum Tally or above. For example, any Snippet that receives more than 500,000 up-votes can qualify to be in the Trending Snippets Category.

Embodiments of the subject invention bridge the gap between internet content and television broadcasting by providing the Snippets in the Trending Snippets Category to a broadcast network to be broadcast, for example, as part of, or incorporated with, television programming. The broadcast network can analyze each received Trending Snippet, in particular, the length or “run time,” but also other descriptive information associated with the Snippet. The television network can then determine the most appropriate time to broadcast each Snippet. The television network can also generate a schedule of when each Snippet will be broadcast. In one embodiment, one or more trending Snippets are broadcast during one or more breaks in a television program, similar to commercials. Other broadcast options can also be employed by a network. The television network can transmit the broadcast schedule for the trending Snippets to the CIMS, which can provide the Snippet broadcast schedule to Users of the Mobile App. Anyone viewing the program broadcast can see the trending Snippets, which can increase viewership for a program. App users watching the broadcasted snippets can be incentivized to submit Snippets through the Mobile App to compete for a broadcasted Trending Snippet.

The Mobile Application can be monetized by presenting advertisements or commercials to App Users between watching one or more Snippets. Access to certain categories can also be a paid-for service. For example, the Trending Snippets Category could be made accessible only to those App Users that have paid a fee. The television broadcast schedule could also be provided to only App Users that have paid a fee. Other features of the Mobile App could also be monetized by restricting access to App Users that have paid a fee. One particular monetization strategy would be to decrease the number of advertisements an App User receives the longer they watch and vote on Snippets. This can entice Users to watch more Snippets or for a longer time and can increase the value of advertisement time placed later in viewer sessions.

Owner Users whose Snippets are curated by votes to the Trending Snippets Category can obtain at least temporary fame, recognition, and personal gratification. They can receive further encouragement when the Trending Snippet of the Owner User is shown in a television broadcast, where it can be seen by a larger audience. The curation of trending Snippets can also provide examples of successful Snippets and encouragement to other App Users to submit Snippets, thereby increasing participation in the competition for trending Snippet status.

Another advantage that can be realized with the television broadcast of trending Snippets is an increase in viewership of television programs during which Snippets are shown. Snippets shown during a break in a television program can entice viewers to tune-in to the television program to watch the broadcasted Snippets. This can generate interest in the television program and potentially increase future viewership of the television program in the absence of broadcasting Snippets.

### BRIEF DESCRIPTION OF DRAWINGS

The patent or application file contains at least one drawing executed in color. Copies of this patent or patent application publication, with color drawing(s), will be provided by the Office upon request and payment of the necessary fee.

In order that a more precise understanding of the above recited invention can be obtained, a more particular description of the invention briefly described above will be rendered by reference to specific embodiments thereof that are illustrated in the appended drawings.

FIGS. 1A and 1B show block diagrams of network systems on which embodiments of the computer implemented methods and systems (CIMS) for curating multimedia content can operate. The network systems shown provide only representative illustrations of network systems and should not be construed as limiting regarding other network systems on which different embodiments can be implemented.

FIG. 2 is a flow chart that demonstrates an exemplary method in accordance with the computer implemented method and system (CIMS) for utilizing the Mobile Application to view Snippets, upload Snippets, and provide the Trending Snippets to a broadcast network for television broadcast.

FIG. 3 is a screen shot of one embodiment of a Start-up interface screen for the Mobile Application, according to the subject invention.

FIG. 4 shows a screenshot of one embodiment of a Log-in interface screen for the Mobile Application, according to the subject invention.

FIG. 5 shows a screen shot of one embodiment of a Registration interface screen for the Mobile Application, according to the subject invention.

FIG. 6 shows a screen shot of an embodiment of a Registration interface screen for the Mobile Application, according to the subject invention.

FIGS. 7A and 7B show screen shots of embodiments of the Recovery interface screen screens for the Mobile Application, according to the subject invention. FIG. 7A shows the screen shot for the Recovery interface screen for requesting to change a password or other User information. FIG. 7B shows the screen shot of the subordinate Recovery interface for inputting the new password or other information.

FIG. 8A shows a screen shot of an embodiment of a Home interface screen for the Mobile Application, according to the subject invention.

FIG. 8B shows a screen shot of an embodiment of the Home interface screen when scrolled to show additional categories, according to the subject invention.

FIG. 9 shows a screen shot of an embodiment of a Snippet listing interface screen for the Mobile Application, according to the subject invention. Also shown is an example of a Modified Broadcast Schedule pertaining to a selected Snippet.

FIG. 10A shows a screen shot of an embodiment of a Snippet interface screen that includes a Snippet interface window for the Mobile Application, according to the subject invention.

FIG. 10B shows a screen shot of an embodiment of a Snippet interface window in landscape mode for the Mobile Application, according to the subject invention.

FIG. 11 shows a screen shot of an embodiment of a Report interface screen for the Mobile Application, according to the subject invention.

FIG. 12 shows an embodiment of a Record video interface screen for the Mobile Application, according to the subject invention.

FIG. 13 shows an embodiment of an Add Details interface screen for the Mobile Application, according to the subject invention.

FIG. 14 shows an embodiment of a Snippet Category select interface screen for the Mobile Application, according to the subject invention.

FIG. 15 shows an embodiment of a Description interface screen for the Mobile Application, according to the subject invention.

FIG. 16 shows an embodiment of Description interface screen with an example narrative input for a Snippet, according to the subject invention.

FIGS. 17 and 18 show embodiments of Progress screens for the Mobile Application, according to the subject invention.

FIG. 19 shows an embodiment of a Warning interface screen for the Mobile Application, according to the subject invention.

FIGS. 20A, 20B, 20C, 20D, 20E, and 20F show screen shots of embodiments of an Owner User Dashboard interface screen for the Mobile Application, according to the subject invention. FIG. 20A shows an Owner User Dashboard that includes a Snippet listing.

FIGS. 20B and 20C show an Owner User Dashboard that includes editable identifying information about the Owner User along with variations in a Snippet listing. FIG. 20D shows an example of a subordinate Edit profile interface screen. FIG. 20E shows an example of an Owner User Dashboard with a dropdown menu. FIG. 20F shows an example of a Push Notification Preferences screen.

FIG. 21 shows an embodiment of an Owner Snippet interface screen for the Mobile Application, according to the subject invention. Also shown in an example of a Modified Broadcast Schedule specific to the Snippet.

FIG. 22 shows an embodiment of a subordinate Edit Snippet interface screen for the Mobile Application, according to the subject invention.

FIGS. 23A and 23B show embodiments of push notifications, including Text notification screens for the Mobile Application, according to the subject invention. FIG. 23A shows a text notification screen that lists the App users and the date and time their respective votes were cast for the Snippet. FIG. 23B shows a text notification screen that also includes a link for each App user that voted, which navigates to a Profile screen for that App user.

FIGS. 24A, 24B, and 24C show embodiments of broadcast schedules. FIG. 24A shows an example of a Broadcast Schedule that can be generated by a broadcast network and that can be prepared for access by the Mobile Application, according to the subject invention.

FIG. 24B shows a Modified Broadcast Schedule that includes information for multiple Snippets and available to Mobile App users. FIG. 24C shows a Modified Broadcast Schedule that includes information for a specific Snippet and is made available through the mobile application.

FIG. 25 shows a Trending snippet being broadcast by a broadcast network.

### DETAILED DISCLOSURE

The subject invention pertains to embodiments of a computer implemented method and system (CIMS) for curating multimedia content obtained through the internet and presenting the curated multimedia content as a television broadcast. More specifically, the subject invention provides embodiments of a CIMS that can receive multimedia content from Users of a Mobile Application and provides options for Users to view and provide an opinion or vote on the multimedia content. The CIMS can calculate a Tally of the opinions or votes of Users to determine the multimedia content will be assigned to a special Trending Snippets Category for popular or “trending” multimedia content. Furthermore, the multimedia content curated by Users to the special or “Trending” Snippets Category can be periodically provided or sent to a broadcast network or other broadcast provider to be scheduled for broadcast.

Software embodiments of the subject invention include a Mobile Application that App Users can download to a client device. App Users can employ the Mobile Application to view and, if desired, to vote on the multimedia content. The multimedia content can include a variety of images and sounds and will usually be in the form of short videos or “Snippets”. Advantageously, the Mobile Application can provide App Users with an option and tools for uploading one or more Snippets created by an Owner User. An App User that creates a Snippet is referred to herein as an Owner User and the Snippet that the Owner User creates is referred to herein as an Owner Snippet. When an Owner Snippet is uploaded to storage media accessible by the CIMS it becomes a Snippet in the Snippet Library and can be accessed by other App Users. The Mobile Application can also provide options for the modifying or editing details of the Owner Snippet, including adding one or more descriptors, such as a Category to which the Snippet will be associated, narrative description of the Snippet, and one or more descriptive words or “tags” which can facilitate searching for the Snippet in the Snippet Library on the server system.

Owner Snippets that have been uploaded or submitted to the computer memory become Snippets accessible by the CIMS and are made available to other Users to view and submit an opinion or vote thereon. The votes for each Snippet in the Snippet Library are calculated by the CIMS and to obtain a Tally of each vote for each Snippet. Each Tally can be indexed, ordered, or otherwise arranged to determine which Snippets have the higher vote Tallies. Snippets with a greater number of votes or a higher Tally, often referred to as “trending”, can be assigned to a special Trending Snippets Category. The Trending Snippets Category can be limited to a specific number of Snippets, so only those with a sufficiently high Tally will be eligible for inclusion. Alternatively, the number of Snippets in the Trending Snippets category can vary depending on the content, characteristics, or number of Snippets in the Snippet library at any given time. Voting trends can also determine the number of Snippets in the Trending Category. Thus, the Trending Snippets Category can be dynamic, such that the Snippets therein can periodically change and Snippets can be replaced or “knocked out” of the Trending Snippets Category by other Snippets that obtain a higher Tally or Rank. In one embodiment, the Trending Snippets Category has s limited number of Snippets, for example, 1000 Snippets, at any time. Thus, only the Snippets with the top 1000 Ranks will be in the Trending Snippets category. In an alternative embodiment, Snippets that have a minimum number of up-votes or other positive votes are included in the Trending Snippets Category. By way of example, only Snippets that have received 500,000 or more up-votes can be in the Trending Snippets Category. In another alternative embodiment, a certain percentage of the top ranked Snippets are selected for the Trending Category. An example would be to select the Snippets Ranked in the top 10% to include in the Trending Category.

Snippets in the Snippet library, unless removed by Owner User, can always be accessed by App Users. The CIMS can ensure that the newest Snippets are at the top of the Snippet Listing Screen. Some Snippets may be played less often over time, as they move further down the Snippet Listing Screen, and others may become classics that always have a certain number of views. As such, it is possible for older Snippets to be rediscovered by App Users and possibly selected for the Trending Category.

At a particular pre-determined time, the Snippets in the Trending Snippets Category can be sent, for example, by the CIMS, to a broadcast network, which can include, for example, a television network, a television broadcast station, network affiliates, or other entity that operates to provide television broadcasts. The Snippets can be arranged, formatted, or otherwise prepared by the broadcast network or other broadcast entity for broadcast on, such as, for example on television 140, as shown in FIG. 25. The broadcast network can provide to the CIMS a broadcast schedule for the Snippets. In one embodiment, to encourage download of the Mobile Application, the broadcast schedule, or a portion thereof, can be provided only to App Users through the Mobile Application.

The method of curating Snippets with votes for determining eligibility for eventual television broadcast to a potentially larger audience can, advantageously, create competition between Users. Such competition can encourage Users to submit Snippets more likely to appeal to Users of the Mobile Application, which can improve the content and quality of the Snippets. Users that have submitted a Snippet through the Mobile App can also receive one or more push notifications that informs the User each time certain events occur regarding an Owner Snippet. For example, the User can receive a text message, audio message, or other notification when, for example, the Snippet is viewed, voted on, changes in rank, or other action is taken or occurs regarding the User's Snippet. Push notifications can provide positive feedback and validation to an Owner User and can encourage Users to submit more Snippets.

In one embodiment, the Trending Snippets that become eligible for inclusion in the Trending Snippets Category can be sent, for example, by the CIMS on the server system, to a broadcast network. The broadcast network can organize the Snippets for television broadcast. In one embodiment, the Snippets are arranged to be broadcast during breaks in regular scheduled programming, like commercials. The broadcast network can create a broadcast schedule that includes each Trending Snippet. In one embodiment, the broadcast schedule is sent to the server system, where the CIMS subsequently formats and/or provides at least a portion of the broadcast schedule for access by App Users of the Mobile Application. Users can then access or “tune-in” to the broadcast using various television broadcast options to watch the broadcasted Trending Snippets.

Monetization of the CIMS can be accomplished by strategically presenting paid-for advertisements to an App User viewing Snippets. Trending Snippets can also provide an opportunity for network broadcasters to increase viewership of programs. For example, broadcast programs can increase viewership by scheduling Trending Snippets during scheduled breaks in that program. Users of the Mobile App that typically do not watch the program may tune-in to watch Trending Snippets scheduled during that program's breaks, which can generate more interest in the program, thereby increasing future viewership.

In the description that follows, several terms are used that pertain to the subject invention. In order to provide a clear and consistent understanding of the specification and claims the following definitions are provided.

The term “client device” is used herein for literary convenience and refers to any internet-enabled computing device with a display that can include, but is not limited to, computing devices, such as desktop computers, laptop computers, tablets, personal digital assistants (PDAs), mobile phones (including smartphones), wearable devices, electronic book readers, other wireless devices, set-top or other television boxes, media players, game platforms, virtual reality display devices, augmented reality display devices, and kiosks. A client device used with embodiments of the subject invention can access the computer implemented method and system (CIMS) over a network, which can be a local area network or a wide area network, such as the Internet. The client device can also be capable of obtaining, transmitting, and viewing multimedia content in any one or more formats, for example, hypertext markup language (HTML) format, Windows®, audio-video format, QuickTime format, Adobe PDF, MP4, 3PG, WEBM, TS, MKV, .gif, and other proprietary and non-proprietary or open formats.

The term “User” as used herein, refers to one or more persons utilizing the Mobile App on a client device, which can include, but is not limited to, downloading the Mobile App to the client device, viewing one or more Snippets on the client device, providing an opinion or vote on a Snippet through the Mobile App, uploading a Snippet to the CIMS through the Mobile App, creating a User Profile, or using any of the features and options provided by the Mobile App. The term collectively includes a first User, one or more second Users, one or more third Users, and the like, continuing to one or more n^{th} User. It should also be understood that the term User can represent a group, organization, company, corporation, or other plurality of individuals.

As used herein, the term “Snippet” refers to content that can be displayed, viewed, heard, or otherwise accessed by a client device. A Snippet can include different combined and individual formats, for example, text, audio, video, audio-visual, still images, animations, and rich content formats. It can also include 3-dimensional images, such as, for example, holographs.

The term “Owner User”, as used herein, is a specific reference to an App user that has uploaded a Snippet the Owner User created to the Snippet Library for access by other App users.

The term “Owner Snippet,” as used herein, is a specific reference to a Snippet created by an Owner user. An Owner Snippet that is added to the Snippet Library is subsequently referred to as a Snippet.

The terms “Mobile Application” or “Mobile App” are used interchangeably herein and refer to a portion or module of the CIMS that can be executed on a client device. A Mobile Application or Mobile App can download, such as, for example, through an internet access, or accessed through stand-alone or separate memory, such as a flash drive or memory disk, or some combination thereof. The Mobile App on a client device can be utilized interface with the CIMS, for example, to view Snippets, provide an opinion on a Snippet, upload a Snippet, provide descriptive information about the uploaded Snippet, and create an App User profile, and perform other functions and options, as described.

As used herein the term “server system” refers to a computer system comprising one or more computers or memory storage devices that receives requests and provides responsive information. A server system can further be a computer system that receives, stores, and provides data. More specifically, a server system provides and organizes access to resources for other computers linked thereto or that manages centralized data storage or network communications resources. In some implementations a server system can be a computer running administrative software that controls access to all or part of a network and associated resources (such as disk drives or printers). A computer acting as a server makes resources available to client devices on the network.

Also, as used herein, and unless otherwise specifically stated, the terms “operable communication,” “operable connection,” “operably connected,” “cooperatively engaged,” “operably attached,” and grammatical variations thereof mean that the particular elements are connected in such a way that they cooperate to achieve their intended function or functions. The “connection,” “engagement,” or “attachment” may be direct, or indirect, physical, or remote.

It is to be understood that the Figures and descriptions of embodiments of the present invention have been simplified to illustrate elements that are relevant for a clear understanding of the invention, while eliminating, for purposes of clarity, other elements that may be well known. For example, certain navigation controls that are ubiquitous to Mobile Apps for navigation on display screens have not been discussed in detail. Furthermore, where specific details are set forth, a person of skill in the art will understand that various embodiments may be practiced without these specific details. In other instances, well-known processes, methods, structures, and techniques have not been shown in detail in order not to obscure the understanding of this description.

The present invention is more particularly described in the following examples that are intended to be illustrative only because numerous modifications and variations therein will be apparent to those skilled in the art. As used in the specification and in the claims, the singular for “a,” “an” and “the” include plural referents unless the context clearly dictates otherwise.

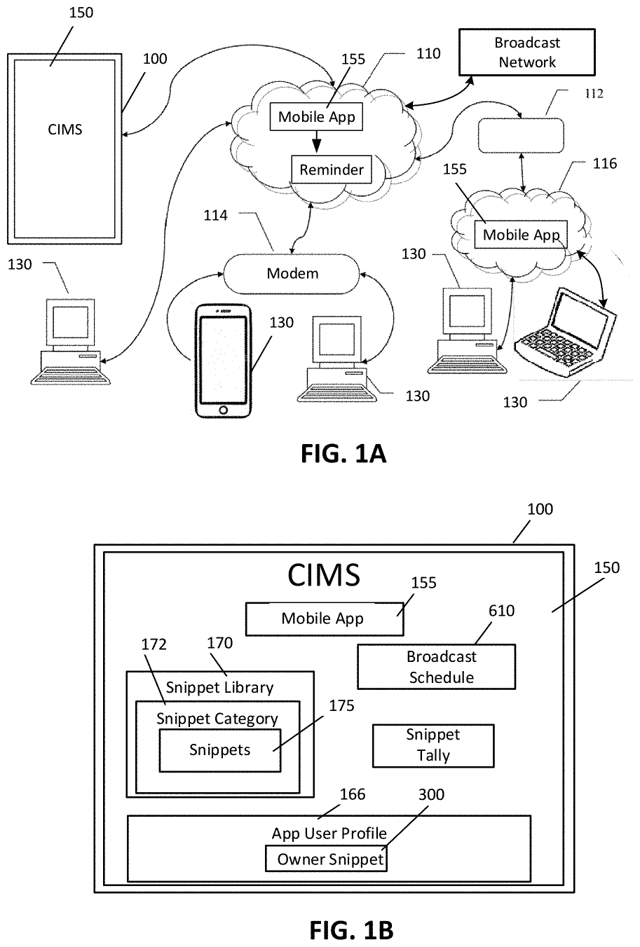

Embodiments of the subject invention can operate in various network environments. In one conventional network architecture, shown in FIG. 1, a server system 100 is operably connected to a wide-area network 110. The wide-area network can include the Internet, or other proprietary networks, which are well known to those of ordinary skill, in the art. Wide-area network may also include conventional network backbones, long-haul telephone lines, Internet service providers, various levels of network routers, and other conventional means for routing data between computers. Using conventional network protocols, the server system 100 can communicate through the wide-area network with a plurality of client devices 130. For example, a client device can be connected directly to the wide-area network through direct or dial-up telephone or other known means of network transmission. Alternatively, client devices can be connected to the wide-area network using a modem and/or router. In an alternative network topology, a wide-area network is connected to a gateway computer or content delivery network 112 to route data to client devices through a local area network (LAN) 116. It should be understood that any part of a network topology employed with embodiments of the subject invention can incorporate wireless communications that can include radio wave or digital transmission through a wireless service provider, or other arrangements known to those with skill in the art.

Using one of a variety of network connection means, the server system can communicate with a client device using conventionally known means. In a particular implementation of this network configuration, a server system can operate as a web server when using the Internet's World-Wide Web (WWW) for wide area network. Using, by way of non-limiting examples, the HTTP or FTP protocol and, also by way of non-limiting examples, the HTML, JavaScript, or Ajax coding languages across wide-area network, web server may communicate across the World-Wide Web with client devices. Likewise, the Mobile App when installed on a client device can access the server computer. It is within the skill of a person trained in the art to determine any of a variety of hardware and related software configurations that can be utilized with embodiments of the subject invention to facilitate communication between the server computer and a client device. Variations in the configuration of the network topology that provide the same functionality, in substantially the way as described herein, with substantially the same desired results, are within the scope of this invention.

The Mobile App can be utilized to access and view at least one Snippet 175, which can be arranged in a Snippet library 170 managed by the CIMS, described in detail below. A Snippet can be acquired from any of a variety of sources, but ideally is generated and provided by an App User of the Mobile App. A Snippet can be stored on a database comprising the Snippet library. In one embodiment, a Snippet is located on the server system 100. In an alternative embodiment, a Snippet is located on separate storage media 120, such as, by way of non-limiting example, cloud-based storage, accessible by the server system. The Snippet can be stored in any conventional format suitable for the content of the Snippet. If a Snippet comprises multimedia content, such as, for example, a video, the video file can be stored in a raw or compressed video and audio data format. The compressed video data may use the H.264, VP8, MPEG-4, MPEG-2, RealVideo, Theora, Dirac, or another suitable video compression format. The compressed audio data may use the mp3, AAC, Ogg, MPC, AC3, RA, or another suitable audio compression format. If the Snippet is a static image, it can be stored as a .jpg, .gif, .tiff, .gmp, .pdf, .png, .bmp, and any other known file format. Variations in any of the file formats utilized with embodiments of the subject invention that provide the same functionality, in substantially the way as described herein, with substantially the same desired results, are within the scope of this invention.

In some embodiments, the database includes at least one computer storage medium with a network connection to the server computer, which provides the Snippet 175 to an App User. The Snippet can be stored on the database for an indefinite period of time until a decision is made to delete the Snippet. In some cases, the Snippet will be deleted from the database based on date of creation, the existence of newer Snippets, video rating, vote status, or other factors. As an example, a Snippet that has been sent to broadcast network may be deleted from the Snippet library 170 or, by way of another example, a Snippet having fewer than a certain number of views in given period, or has a Tally 510 of votes below a certain threshold may be deleted from the Snippet library. In one embodiment, a Snippet removed from the Snippet library is saved or archived at another location and is not accessible by or provided to an App User. The database can also store multiple copies of the Snippet on multiple computer storage mediums. This can form a backup enabled system so that the Snippet will not be lost in the event a computer storage medium fails.

The Snippets are made available to client devices 130 through the Mobile App 155. In one embodiment, the server system provides open access to a Snippet, such that the Snippet is made available to any client device that has downloaded, executed, or is operating on the Mobile App and such open access does not necessitate identifying the App User or the client device to the server system. For example, the Mobile App can be accessed and/or downloaded from a website. This allows the Mobile App and server computer to provide a Snippet as a free service. In an alternative embodiment, a Snippet is available proprietarily, such that one or both of an App User and client device is required to log-in, complete some process, or provide some information by which an App User, client device, or both are identifiable to the server system.

A Snippet 175 can be associated with or assigned to at least one Snippet Category 172 of a plurality of Snippet Categories within a Snippet library 170. A Snippet Library can comprise all of the Snippets on the server system 100. In one embodiment, open access to all App Users can be provided to a limited number of Snippet categories. In an alternative embodiment, all or additional Snippet categories can be provided to an App User after a log-in process has been completed. In yet another alternative, there can be paid-for Snippet categories accessible only after a log-in procedure is complete and a fee has been paid by the App User.

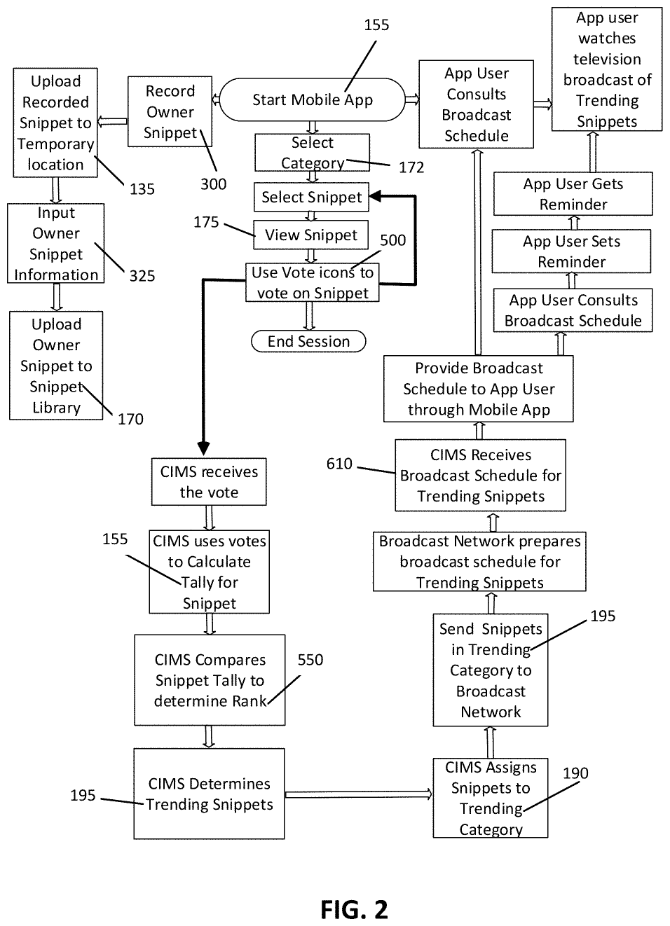

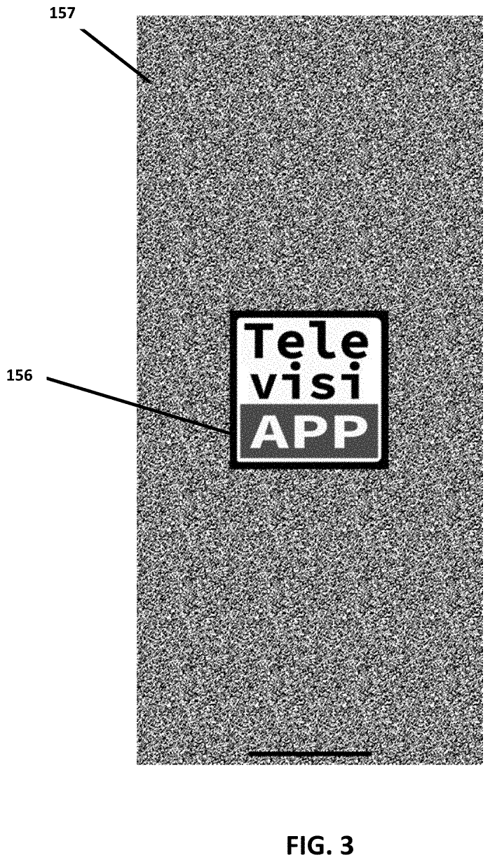

With reference to the Figures, an exemplary embodiment of the methods and processes performed by or in relation to the CIMS 150 of the subject invention is shown in FIG. 2. In one embodiment, the CIMS includes a Mobile App 155 that, at the outset, an App User can download to the client device 130. The Mobile App can provide one or more interface screens, described herein, by which the User can interact with the Mobile App and the server 100. The Mobile App can be obtained through any known digital distribution platform from which computer software can downloaded for the client device. Typically, a Mobile Application is selected through a distribution platform, which allows download of the Mobile App, or some part thereof, to the client device. In one embodiment, the Mobile App when installed on the client device can provide a start button or App Icon 156 that can be selected or “clicked” to activate the Mobile App on the client device. FIG. 3 illustrates one example of an App Icon. The ability to download Mobile Apps to a client device is known in the art and the subject invention is not limited to any particular distribution platform for downloading the Mobile App of the subject invention to a client device.

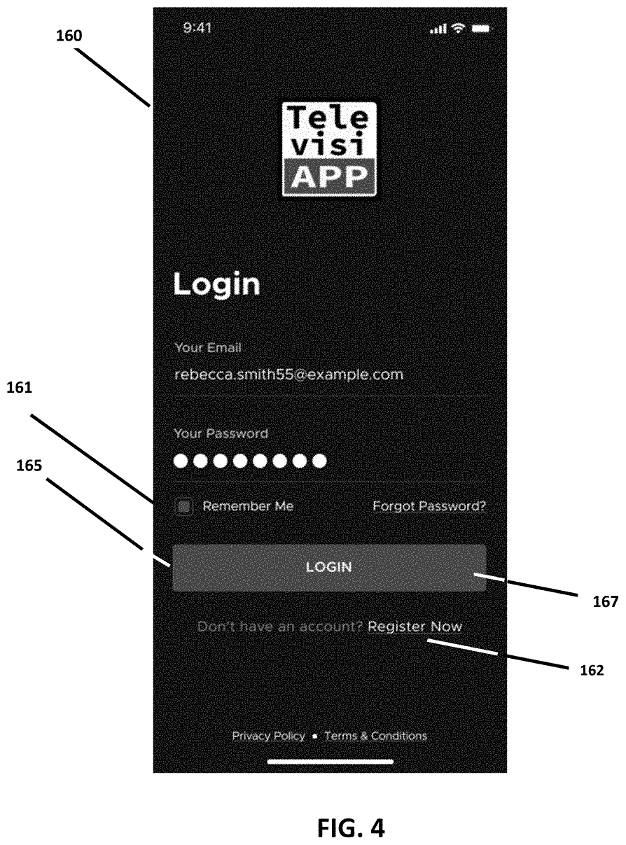

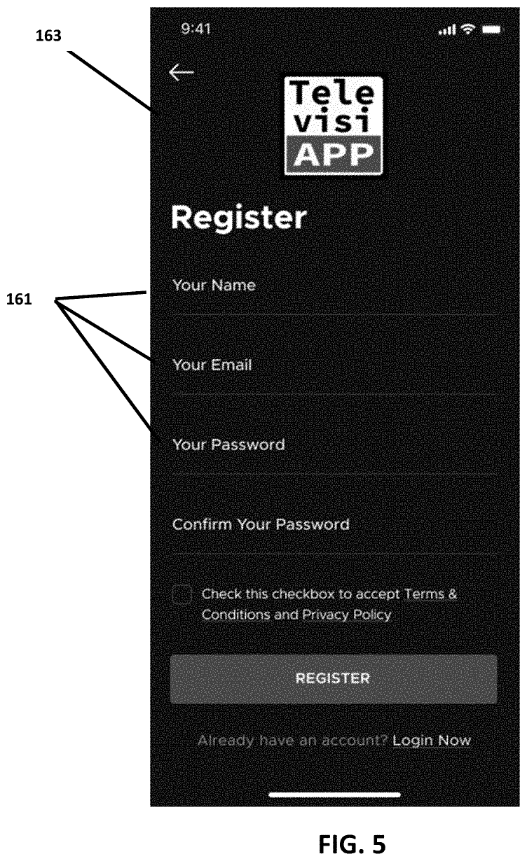

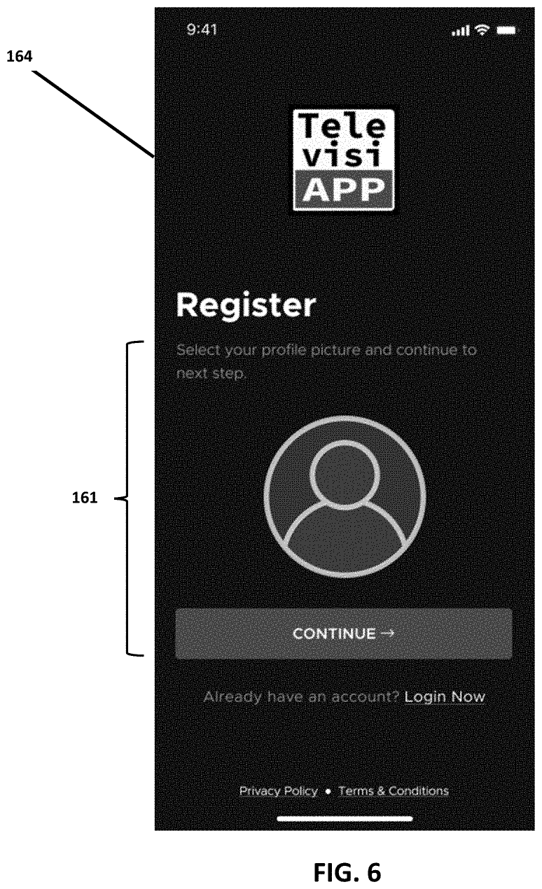

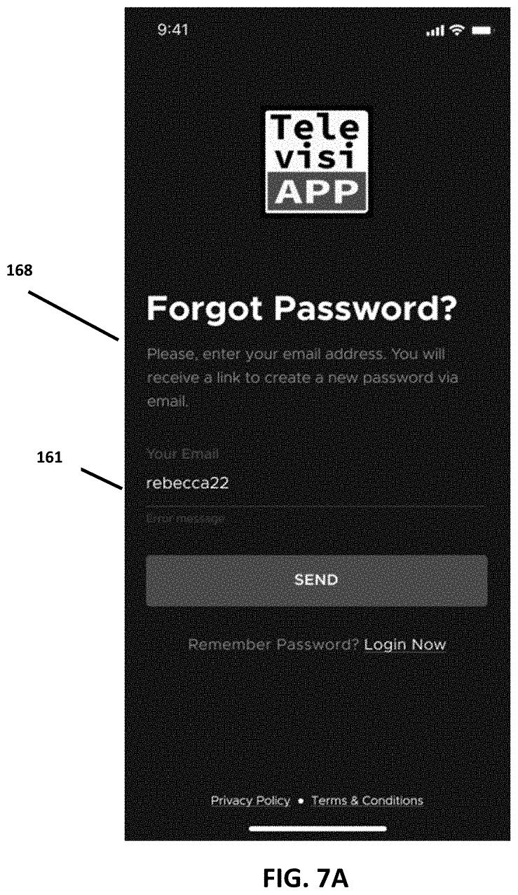

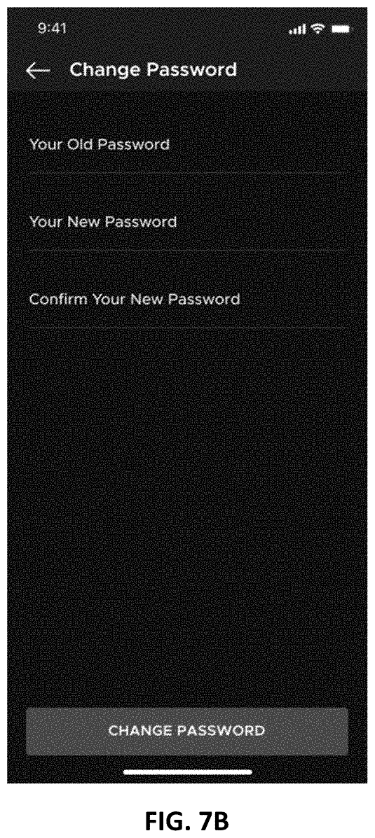

The server computer 100 comprising an embodiment of the CIMS can be accessed by the Mobile App downloaded on a client device 130. When the App Icon 156 is used the Mobile App 155 can display on the client device 130 a log-in interface screen 160 with one or more identifying information input fields 161 in which the App User can input personal information to create an App User Profile 166 that identifies the client device and/or the App User to the server computer 100. FIG. 4 shows one embodiment of a log-in interface screen. For example, identifying information can be one or more of a password, Username, and email address associated with the App User and that identifies the App User and authorizes the client device to access to the server system. In a further embodiment, an App User requesting access to the server system for the first time can select a Registration button 162 on the log-in interface screen that displays a subordinate Registration interface screen 163 with identifying identification input fields 161 for an App user to enter and register identifying information with the server system. FIG. 5 shows an example of a subordinate Registration interface screen 163. In one embodiment, the Registration Interface screen can display a further subordinate Profile interface screen 164 with additional identifying information input fields 161. Additional information can include, for example, a profile picture, name or pseudonym, personal description, and other information that may be useful of interest to other App Users, as shown, for example, in FIG. 6. Certain identifying information can appear on an App User Dashboard interface screen 450, discussed below. Once a registered App User has completed the log-in and/or registration process, the server system can recognize and authorize the App User Profile 166 to allow the App User access the server computer when contacted with the Mobile App on the same or a different client device. In a further embodiment, the log-in interface screen 160 can include a Remember button 165 that instructs the Mobile App to save and automatically insert the identifying information that was input by registered App User next time the Mobile App is accessed. In a still further embodiment, there can be a Recover button 167 on the log-in interface screen that can be selected by the registered App User to change or recover a password, or other previously input identifying information. The Recover button when selected can display a subordinate Recovery interface screen 168, as shown, for example, in FIG. 7, which has at least one identification input field that can be used to recover other identifying information, such as a password. Log-in interface screens are known in the art and the subject invention is not limited to the type or quantity of identifying information required on a log-in interface screen or the additional actions that can take on a log-in interface screen with regard to identifying an App User and client device to a server computer.

Upon initiating, executing, or starting the Mobile App, a Splash screen 157 can be displayed on the client device. The Splash screen can be a graphic that represents the Mobile Application, for example, a graphic representing the App Icon 156 can be shown on the Splash screen. A Splash screen can include, for example, the name of the Mobile App, creators, company name, and any other introductory information. FIG. 3 shows one example of a Splash screen for the Mobile App 155 that includes an image of the App Icon.

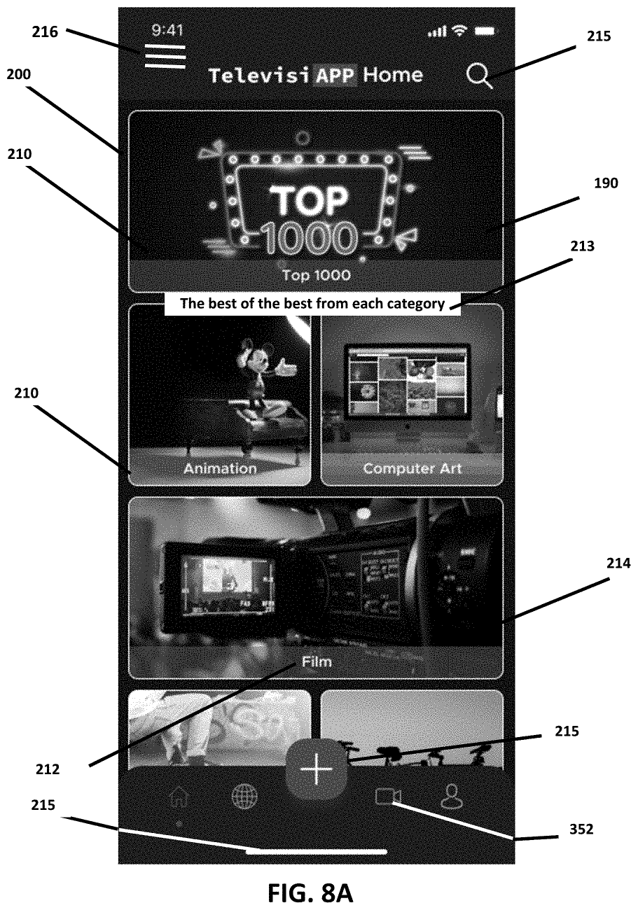

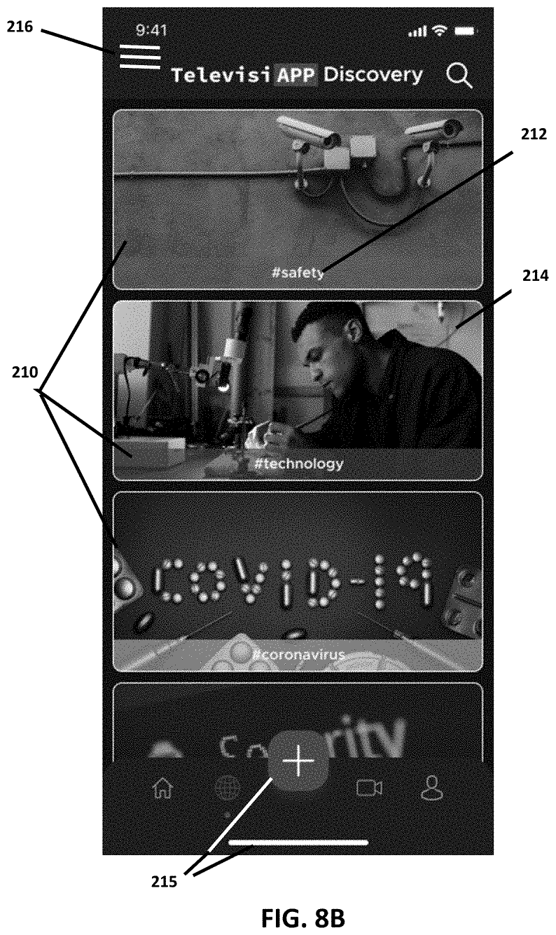

In one embodiment, a Home Interface screen 200 can be displayed and is an initial interface for accessing the Snippet library 170. The Home interface screen can comprise multiple Category select buttons 210, such as shown, for example, in FIGS. 8A and 8B. In one embodiment, a Category select button can include a Category name 212. It can be beneficial for an App User to know what types of Snippets are available within a particular Category. Snippets 175 can be arranged or associated with one or more categories 172 of a Snippet library 170. In one embodiment, a Category description 213 can be included as part of the Category select button or as separate textual feature associated with the Category select button, for example, there can be Category description below a Category select button. In a specific embodiment, a Category description is one or more keywords or terms, often referred to as “tags”, which briefly and succinctly describe the content of the video. FIG. 8A shows an example of a Category select button with a Category description 213. In a further embodiment, a Category select button can comprise a Category visual cue 214. For example, the Category select button can comprise a graphic that is generally representative of the type or style of Snippets available in that Snippet Category. In an alternative example, a Category select button can comprise a short, few second, repeating video over which the Category name is shown. A Category select button can be used, for example, by navigating to and “clicking” on a Category select button, to display a subordinate Snippet listing interface screen 220. As such, there can be various navigation controls 215 provided for navigating the Home interface screen 200 to select Category select buttons, conduct a search of the categories, an advance or scroll button to show additional Category select buttons that are off-screen, as well as other navigation controls on other screens, discussed below. There can also be one or more Menu buttons 216 that can be selected to show further actions that can be taken, which are described below. FIGS. 8A and 8B show embodiments of a Home interface screen 210 with a plurality of Category select buttons and navigation controls. FIG. 8B shows the Home interface screen scrolled to view other Category select buttons available from the Home Screen.

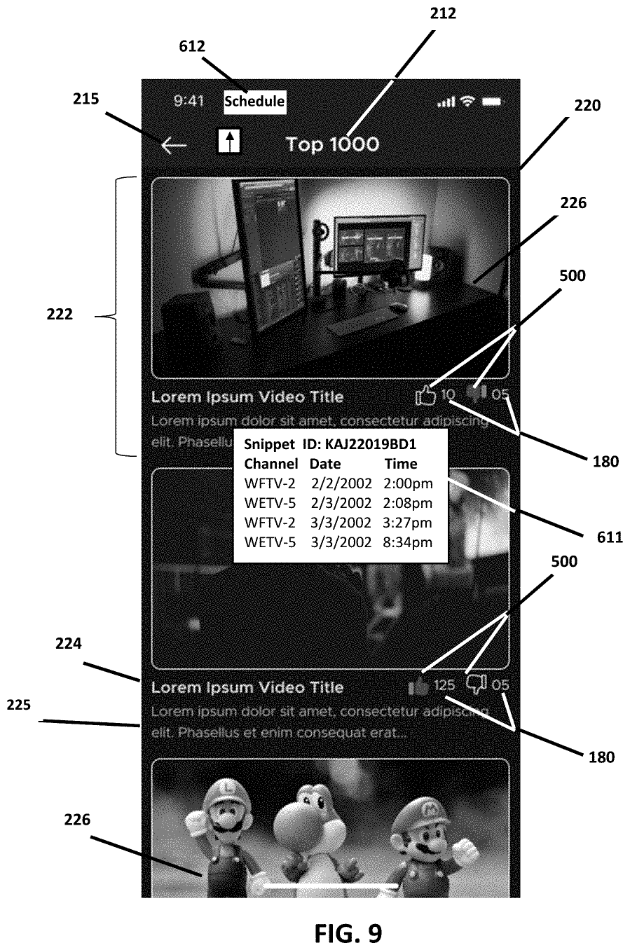

A Snippet Listing interface screen 220 can comprise one or more Snippet select buttons 222 that can be used to navigate to a Snippet Interface screen 230. A Snippet listing interface screen can also include the Category name 212. In one embodiment, a Snippet select button includes or has been associated therewith a Snippet title 224. In still further embodiment, a Snippet select button includes or has associated therewith a narrative style Snippet description 225, or a portion thereof, pertaining to the Snippet. In another embodiment, a listing interface screen can include one or more keywords or short phrases, conventionally referred to as “tags”, which briefly and succinctly describe the content of the video. A Snippet title, Snippet description and Snippet tags 228 can provide information about the content of the selected Snippet. In a further embodiment, a Snippet select button can comprise a Snippet visual cue 226. A Snippet visual cue can be, for example, a graphic that is representative of the Snippet. In an alternative example, a Snippet visual cue can include all or a portion of the Snippet itself that repeats as part of the Snippet button. A Snippet select button can be used, for example, by “clicking” on the Snippet select button 222 or some portion thereof, such as, for example, the Snippet visual cue, Snippet title, or Snippet description to navigate to a subordinate Snippet interface screen 230. FIG. 9 shows an example of a Snippet listing interface screen 220 with multiple Snippet select buttons 222 that can be used to navigate to a Snippet interface screen 230.

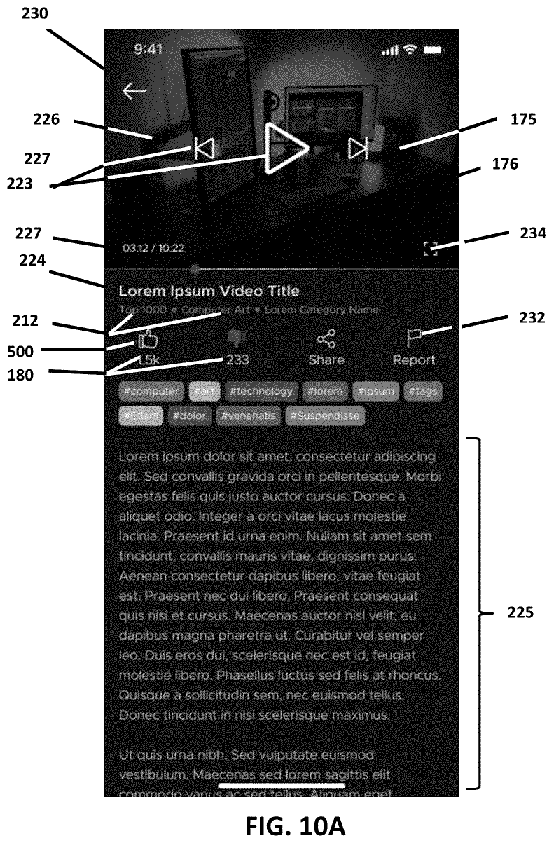

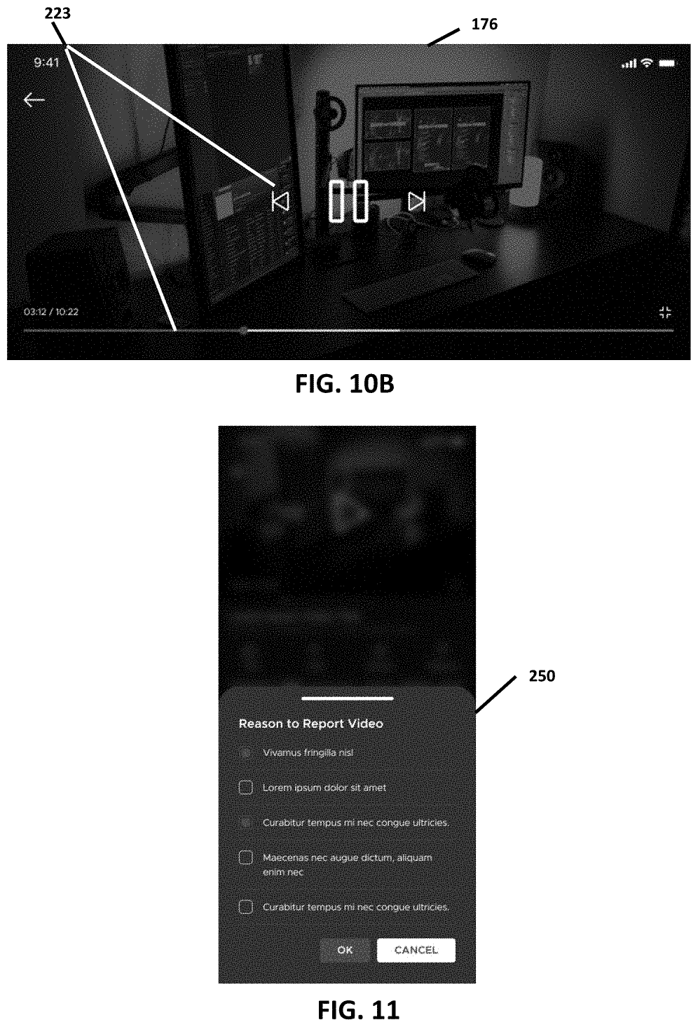

After a Snippet select button has been selected on the Snippet listing interface screen 220, a Snippet interface screen 230 is displayed on the client device 130 for the specific selected Snippet. FIG. 10A illustrates a non-limiting example of a Snippet interface screen. In one embodiment, the Snippet is shown in a Snippet window 176 on the Snippet interface screen, in which the entire Snippet 175 can be played. Various Snippet control buttons 223 can also be provided on the Snippet window or the Snippet interface screen, such as, but not limited to, play, back, pause, times slider, and other features useful when viewing multimedia. There can also be a clock, timer, or other duration indicator 227 that starts and ends simultaneously with the Snippet.

In one embodiment, the Snippet window 176 is presented on the Snippet interface screen 230, which can be arranged to play in a profile or upright orientation on the client device 130, such that the Snippet is shown on a portion of the client device 130. It can be beneficial or preferred to view a Snippet in “full-screen” or landscape orientation. In one embodiment, Snippet control buttons include a full-screen mode button 234 that enlarges and rotates the Snippet Window, for example, to fill all or most of the display screen of the client device when in landscape or sideways orientation. In a particular embodiment, rotating the client device to a landscape or sideways orientation causes the Snippet window to automatically rotate and format itself to landscape, without utilizing any Snippet control buttons. FIG. 10B illustrates one example of a Snippet window shown in landscape orientation on a client device 130.

In one embodiment, the Snippet visual cue 226 is shown on the Snippet interface screen 230, which can confirm that the Snippet selected on the Home Interface screen 220 is the one provided on the Snippet interface screen. Alternatively, the first frame of the Snippet 175 can be seen on the Snippet interface screen, which can be, but is not required to be, the same as the Snippet visual cue. Additional information about the Snippet can also be provided on the Snippet interface screen. In one embodiment, a Snippet description 225 is shown on the Snippet interface screen. In another embodiment, the Snippet title 224 is shown. A Snippet can be associated with or located in one or more categories 172 in the Snippet Library 170. In one embodiment, the Snippet interface screen includes the Category name 212 associated with the Category select button 210 used to navigate to the Snippet interface screen.

There are some actions that are ubiquitous in Mobile Applications and such actions can also be available to App Users of the Mobile Application of the subject invention. One such action is the ability to share a Snippet with other individuals. A “Share Sheet” button can be provided on the Snippet interface screen 230, for accessing a Share Sheet. Share sheets are known in the art, for example iOS and Android have default Share Sheets that can be utilized with embodiments of the subject invention.

Preferably, a Snippet does not contain inappropriate material or material that does not meet Federal Communications Commission (FCC) guidelines for television programming. Nonetheless, an App User may deem a Snippet to be inappropriate. Embodiments of the Mobile Application can include a Report button 232, such as shown, for example, in FIG. 10A. The Report button can be clicked, selected, or otherwise activated to display a Report interface screen 250 that can be used to report a Snippet to an Administrator of the Mobile Application. The Report interface screen can have a plurality of options for App User input. FIG. 11 illustrates one example of a Report interface screen that lists a plurality of reasons for the inappropriateness of the Snippet and radio buttons for selecting one or more of the reasons, as well as one or more radio buttons for submitting the selections (e.g., and “OK” button) or for canceling the action.

There can also be various navigation tools, informational icons, and menu buttons 216 that are typically used with Mobile Applications. Examples of navigation tools can include Back or return arrows for navigating back to a previous screen, scroll buttons for seeing other portions of the screen on the display, menu buttons that display applicable options available at that particular point or time in the Mobile App, buttons for returning or backing out of a series of subsequent screens, and a Search button that activates an option for conducting a search of the Mobile App, the Snippet library 170, a Snippet Category 172, or other searches. Examples of information icons can include a dock, a Win fan icon to indicate a wireless connection, a battery level indicator, cellular connection bars that indicate the strength of an internet connection, and Tally totals.

In a specific embodiment, the Mobile App 155 has a Play Speed Button 229 that allows the playing speed of a Snippet to be adjusted. Snippets that exceed the required run-time to be included in the Snippet Library can be sped up to play faster, so they do not exceed the desired run-time. When the compressed Snippet is selected by a App User, the sped-up Snippet can be viewed at the saved sped-up run time or the Play Speed Button can be used to slow the play speed of the Snippet. Slowing the play speed of the Snippet increases the run time, but can make it easier for a App User to follow the action in the Snippet. Alternatively, longer Snippets can be sped up to have a shorter run time. In one embodiment, the Play Speed Button is configured to play a Snippet at ¼, ½, 2X and 4X normal or recorded speed. In a further embodiment, the Play Speed Button is a general setting option where selecting a play speed affects play speed of all Snippets selected for viewing. Alternatively, a Play Speed Button can be assigned or associated with each Snippet, such only those Snippets that have been sped-up will include a Play Speed Button to adjust the run time.

Compressed or sped up Snippets that obtain Trending Category status can require additional editing for Television broadcast. In one embodiment, compressed or sped-up Snippets are sent to the broadcast network at the normal playing speed. Ideally, the normal run time for a compressed or sped-up Snippet will not exceed a pre-determined maximum run time. By way of example, the normal play speed of a compressed or sped up Snippet cannot exceed 40 seconds and can be capable of compression to 10 seconds. The Snippet can be saved in the Snippet library in the compressed or sped-up format and the Play Speed Button can be used to slow the Snippet speed when selected by a App User.

In a specific embodiment, there are one or more Vote buttons 500, discussed below, and at least one dynamic Tally total 180 associated with the one or more Vote buttons that show the current number of votes received by the Snippet. Any of these navigation tools, information icons, and menu buttons can appear on one or more of the display screens of the Mobile App. These and other well-known navigation tools and information icons will not be discussed further here except to note that such options can be utilized with the Mobile App embodiments of the subject invention.

As detailed above, Snippets 175 can comprise a variety of material from static pictures or images, animations, video, audio, and variations and combinations in between. Advantageously, the Mobile App embodiments of the subject invention allow App Users to conveniently view Snippets wherever they may be. Snippets that have a shorter length or shorter “run-time” can be easier to watch and can be more practical for broadcast scheduling. Embodiments of a Snippet 175 for inclusion in a Snippet library 170 have a length or run-time of at least 6 seconds, 10 seconds, 15 seconds, 20 seconds, 25 seconds, 30 seconds, 35 seconds, 40 seconds, 45 seconds, 50 seconds, 55 seconds, 60 seconds, 1 minute, 2 minutes, 3 minutes, 4 minutes, and 5 minutes, or a length in a range between any two of the listed values.

Monetization of the Mobile Application can be accomplished by presenting to an App User paid-for advertisements between viewing a certain number of Snippets. Alternatively, paid-for advertisements can be presented after submitting votes for a certain number of Snippets to encourage viewer participation. For example, after viewing a number of Snippets, the App User is presented with an advertisement, before viewing another number of videos. The number of Snippets that can be viewed before presenting an advertisement can be consistent. For example, after viewing five Snippets, an App User is presented with a paid-for advertisement. Alternatively, the number of Snippets viewed before presenting a paid-for advertisement can vary, such that sometimes only a few Snippets are viewed and other times several Snippets are viewed before being presented with a paid-for advertisement. In one embodiment, App Users are presented with more advertisements when starting to view Snippets, but advertisements can taper off or be shown less often as the App User continues to view Snippets. Thus, the longer an App User views and/or votes on Snippets, the less frequently they are presented with advertisements. This can increase the value of paid-for advertisements shown later during a viewing session, since there will be less competition for the App Users attention. It can also be possible for App Users to vote on advertisements, similar to voting for Snippets, which could allow advertisements to compete with Snippets for trending status. Advertisements that receive a high vote Tally 510 could be shown more frequently or shown exclusively during longer Snippet viewing sessions. Advertisements with a higher vote Tally could also be assigned to the trending Snippet Category 190 and forwarded to the broadcast network for broadcast. There could also be a monetary benefit to advertisers that submit paid-for advertisements that make it to the Trending Category, such as, for example, reduced fees or more frequent presentation to App Users. In one embodiment, advertisements that are curated to the Trending Category can be included in the television broadcast.

Snippets 175 can be uploaded, sent, saved, or otherwise stored on the server system 100. Snippets can be obtained from a variety of sources. One source would be the App Users of the Mobile Application 155. App Users can create Snippets having a prescribed run-time length. App users that create a snippet is an Owner user and the they create an Owner Snippet. In one embodiment, the Owner User creates a Snippet that is saved or stored on the client device storage memory, such as, for example, in a photo gallery on the client device. The Mobile Application can provide options for including an Owner Snippet 300 to the Snippet Library 170 on the server system 100. In one embodiment, an Owner Snippet can be added to the Snippet library by an Owner User that has registered with the CIMS and/or that has created an App User profile, as described above.

In one embodiment, an Owner Snippet 300 created using the Record Video interface screen 350 of the Mobile App 155 will automatically be formatted for viewing on the Mobile App by other App Users. In another embodiment, an Owner Snippet created using the Record Video interface screen of the Mobile App will also be automatically formatted to facilitate television broadcast, such that the Owner Snippet does not have to be reformatted prior to being provided to the broadcast network 600. Alternatively, the Mobile App can utilize a format for a recorded Snippet that can facilitate conversion by the broadcast network to a format for broadcast. In one embodiment, Owner Snippets are uploaded directly to the Snippet Library and categorized according to the information provided by the Owner User, as discussed below.

Alternatively, the Mobile App can include an option for temporarily uploading the Owner Snippet to a Secure Location 135 on the server system 100. In one embodiment, the Mobile Applications can provide an option for navigating to the location of the Owner Snippet. Once the Owner Snippet is selected at that location, there can be a further option to upload the selected Owner Snippet to the server system 100 Secure Location 135. The process of navigating to a file location and moving or uploading the file to another location is known in the art and will not be discussed in further detail.

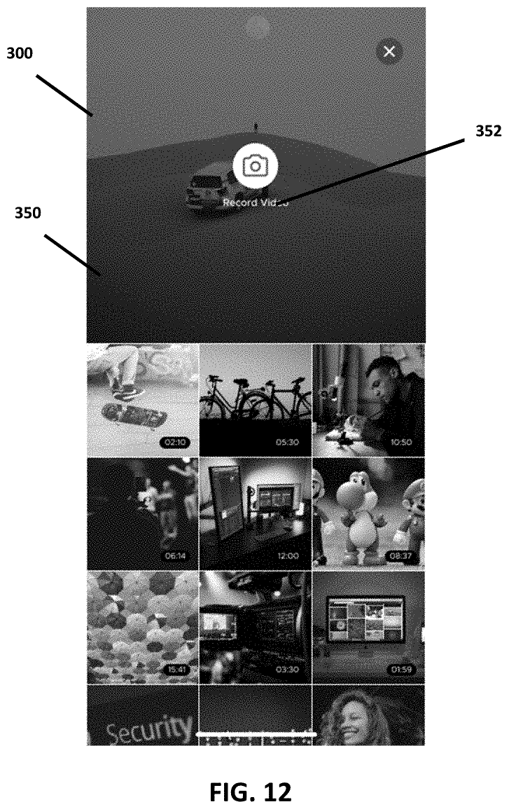

In an alternative embodiment, the Mobile Application can provide an option for recording an Owner Snippet with the camera or other tools of the client device 130. This can be advantageous for recording Snippets of live events or activities. In one embodiment, the Menu button 216 on the Home interface screen 200 can include a selectable option for recording a Snippet. Selecting this record Snippet option can display a “Record Video” interface screen 350, such as shown, for example, in FIG. 12, utilizing a Record button 352, for example a radio button on the Record Video interface screen. The Record Button can activate the camera of the client device. In one embodiment, the camera view is shown on the Record video interface screen. The recorded Owner Snippet can be sent directly to a temporary location 135 on the server system. Alternatively, the recorded Owner Snippet can be saved to the memory of the client device. In one embodiment, the Mobile Application records the Owner Snippet 300 in an acceptable format. In a further embodiment, the Mobile Application records for a maximum time equivalent to the maximum run-time allowed for a Snippet. In an alternative embodiment, the Mobile App records until the Owner User selects another option to end the recording. The Mobile App can provide editing options for cropping the recorded material to the acceptable run-time for an Owner Snippet 300. FIG. 12 illustrates an example of a Record video interface screen 350 with an example of a Record button 352.

One advantage of the subject invention is the ability to provide Snippets directly to a broadcast network, either directly from the CIMS or other means, mentioned above. This can eliminate Owner Users from having to contact the broadcast network directly to arrange for their Snippet to be aired. The CIMS administrator and the broadcast network can negotiate the Schedule requirements, costs, channels, and any other issues in advance, so that Snippets in the Trending Category can be provided to the broadcast network on a regular, established basis. The format used for network broadcast of Snippets can have similarities to the format used for Snippets on the Mobile App. Thus, using the Mobile App Record option can also ensure that the Owner Snippet requires minimal or no formatting when received by the broadcast network 600. By way of example, a Snippet formatted for network broadcast can have embedded audio that is at least −6 db and no more than two black frames prefacing the Snippet and no bars and slate should be used.

The format for a Snippet and network broadcast can be High Definition (HD) or Standard Definition (SD). In one embodiment, the QuickTime format, developed by Apple, Inc. is used by the Mobile App to record Snippets, which is also usable for network broadcasting. Table 1 provides a non-limiting list of HD and SD formats that can be used by the mobile app for recording Snippets usable for both client devices and broadcast networks.

TABLE 1
List of QuickTime HD and SD Preferred Formats
HD/SD FORMATS*

| | | |
|---|---|---|
| QUICKTIME | UNCOMPRESSED 8 BIT | Upper Field First, 1920 × 1080, |
| CODEC: | (not 10 bit) | Audio 48 khz, Frame Rate 29.97 |
| QUICKTIME | H264 | Upper Field First, 1920 × 1080, |
| CODEC: | | Audio 48 khz, Frame Rate 29.97 |
| QUICKTIME | ANIMATION | Upper Field First, 1920 × 1080, |
| CODEC: | | Audio 48 khz, Frame Rate 29.97 |
| QUICKTIME | PHOTO | Upper Field First, 1920 × 1080, |
| CODEC: | | Audio 48 khz, Frame Rate 29.97 |
| QUICKTIME | PRORES | Upper Field First, 1920 × 1080, |
| CODEC: | | Audio 48 khz, Frame Rate 29.97 |
| SD Format - | | Lower Field First, 720 × 480, |
| | | Audio 48 khz, Frame Rate 29.97 |

*All HD formatted Snippets should also be in a 4×3 “safe” mode meaning that all text and graphics should remain within a 4×3″ center portion of the screen. Cable, satellite, and other broadcast network television providers and television delivery services can also convert their signal to the older SD standard.

In one embodiment, the CIMS is configured or has instructions to receive the uploaded Snippet in a temporary location 135 on the server system. In one embodiment, this temporary location can isolate the Owner Snippet 300 and perform standard security checks, such as those known in the art, on the Snippet. If the security check detects a problem with the Snippet, it can be rejected and deleted from the temporary location. The Owner User can be informed that the Snippet was rejected and provided with details as to why the Owner Snippet was rejected. The ability to perform a security check on an Owner Snippet is within the capability of one of ordinary skill in the art and will not be described in further detail here.

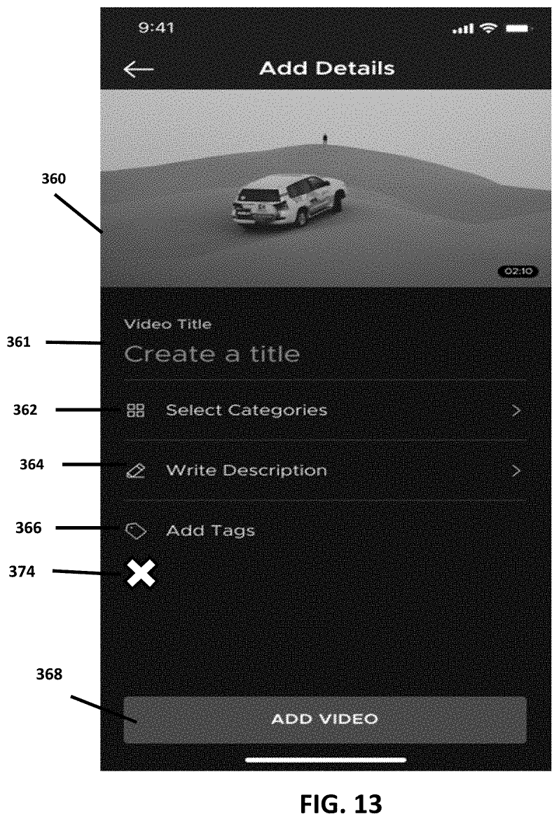

In another embodiment, the Owner User can perform additional actions on the Owner Snippet 300 while located in the temporary location 135. For example, the Owner User is provided with options for adding identifying information that the server system 100 will associate with the Owner Snippet 300. All Snippets can preferably have at least a Snippet title 224, as shown, for example, in FIG. 110A. In one embodiment, the Mobile App displays an “Add Details” interface screen 360 after the Snippet is recorded. The Add Details Interface screen can have buttons to select one or more types of Snippet identifying information to be associated with the Owner Snippet. In one embodiment, the Add Details interface screen provides one or more options, for example, to select one or more Snippet categories 172, write a narrative description 225, and add one or more Snippet tags 228. The Add Details interface screen can also include an option for providing a Snippet title. FIG. 13 illustrates one embodiment of an Add Detail screen 360 that can be used with embodiments of the Mobile Application.

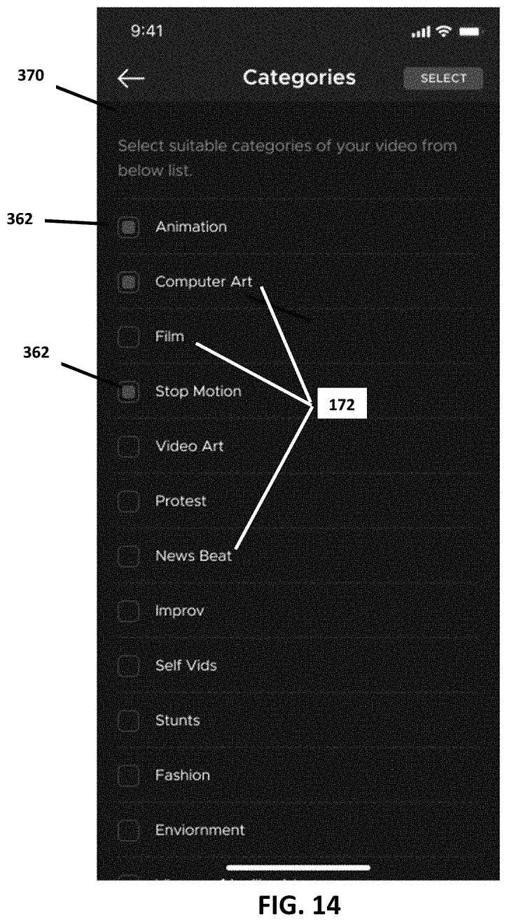

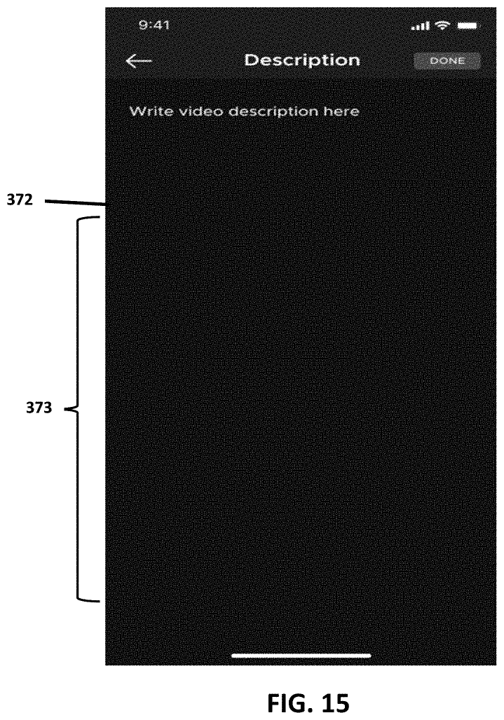

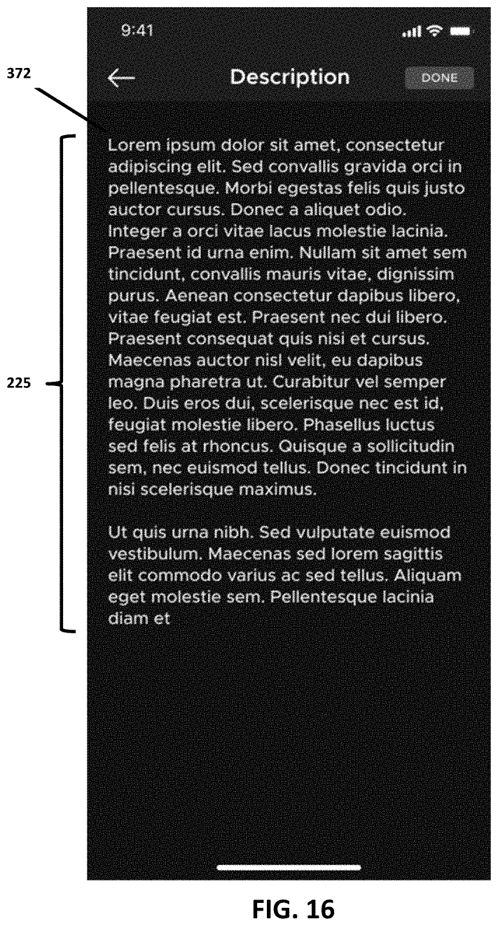

Preferably, all Snippets have at least a Snippet Title 224 by which they can be identified, such as the example shown in FIG. 10A. The Add Details interface screen 360 can include a Title Dialog box 361 in which the Owner User can directly type a title for the Snippet without navigating to another screen. In one embodiment, the Add Details interface screen 360 has a Select Categories button 362 that can be used to display a Snippet Category select interface screen 370, a non-limiting example of which is shown in FIG. 14. The Owner User can select on the Snippet Category select interface screen at least one Snippet Category 172 to which the Owner Snippet 300 is assigned on the server system 100. In another embodiment, the Add Details interface screen has a Write Description button 364 that can be selected to display a Description interface screen 372, one example of which is shown in FIG. 15. The Description interface screen can include a Description dialog box 373 for entering a narrative style Snippet description 225, as shown, for example, in FIG. 16. It can be preferable for a Snippet to have at least one Snippet tag to facilitate searching and/or identifying a Snippet 175 saved to the Snippet library 170. In a still further embodiment, the Add Details Interface screen has an Add Tags Dialog box 366 in which the Owner User can enter at least one tag for the Snippet without navigating to another screen. One example of an Add Tag Dialog box can be seen in FIG. 13.

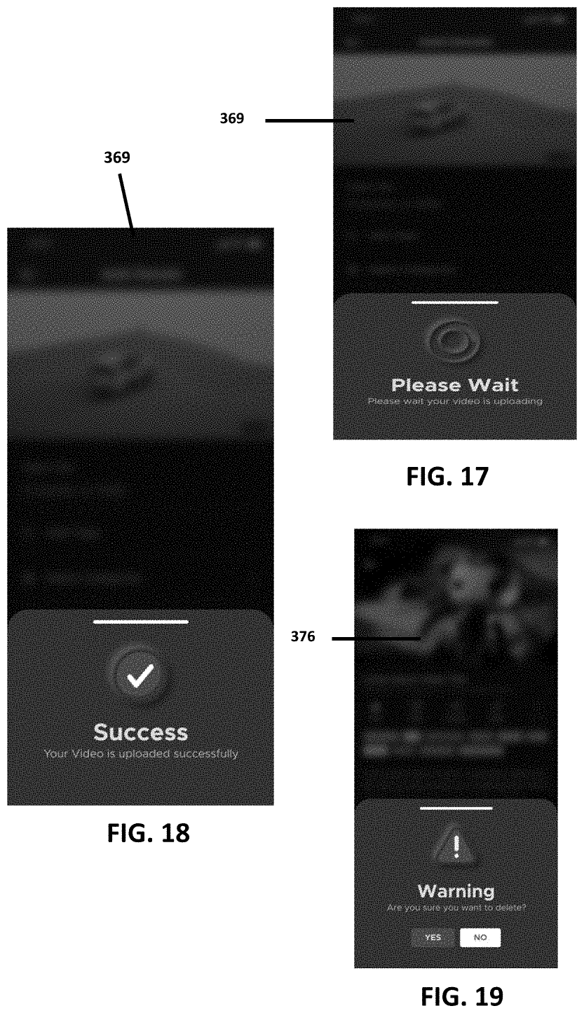

In one embodiment, once the Owner Snippet 300 is uploaded to the temporary storage location 135 and has included descriptive information, the User can request to add the Owner Snippet to the Snippet library 170. Alternatively, the Owner Snippet 300 is uploaded directly to the Snippet Library 170. In one embodiment, the Add Details interface screen 360 includes an Add Snippet button 368 that initiates the procedures for including the Owner Snippet and all descriptive information related thereto in the Snippet library 170 on the server system 100. Subsequent Progress screens 369 can be shown advising the Owner User that the Snippet is being uploaded and when such upload is complete. FIGS. 17 and 18 illustrate non-limiting examples of Progress screens. In one embodiment, Snippets added most recently to the Snippet library will appear at the top of the Snippet listing interface screen 220 for the particular Category 172 until another Snippet is added to the Snippet library in that same Category. Thus, App Users can see the most recent additions to the Category at the top of the Snippet List screen 220.

There can also be an option for an Owner user to delete an Owner Snippet 300 that they uploaded. For example, the Owner User may decide not to upload a Snippet. In one embodiment, the Add Details interface screen 360 can include a Delete Button 374 that can be used to remove the Snippet and any descriptive information before being uploaded to the Snippet library. In a further embodiment, a Warning interface screen 376 can be shown to the Owner User before the CIMS deletes the Snippet. The Warning interface screen, for example, as shown in FIG. 19, can have “Yes” and “No” buttons to confirm the Owner User's decision to delete the Snippet or not. As mentioned above, the server system 100 can include some level of redundancy that can act as a backup for the Snippet library. In one embodiment, the deletion of the Snippet will delete the Snippet from the Snippet library that is accessible to App Users. In a further embodiment, the deletion of the Snippet will delete the Snippet in all redundant locations as well.

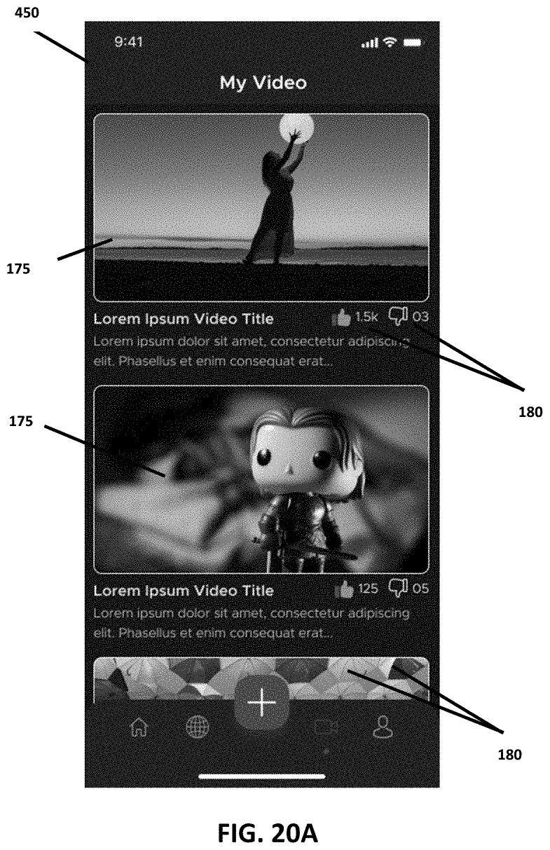

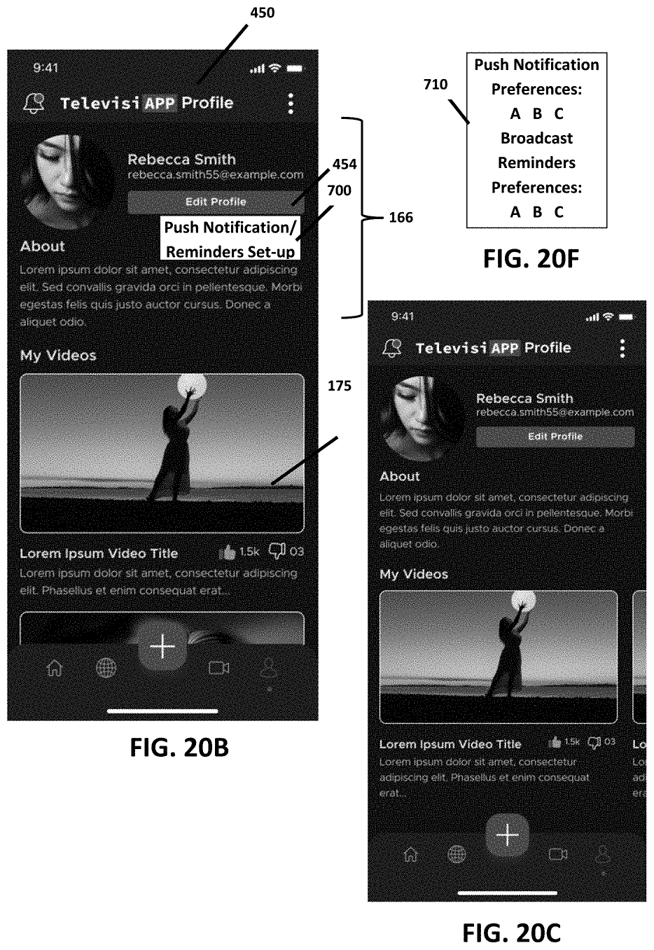

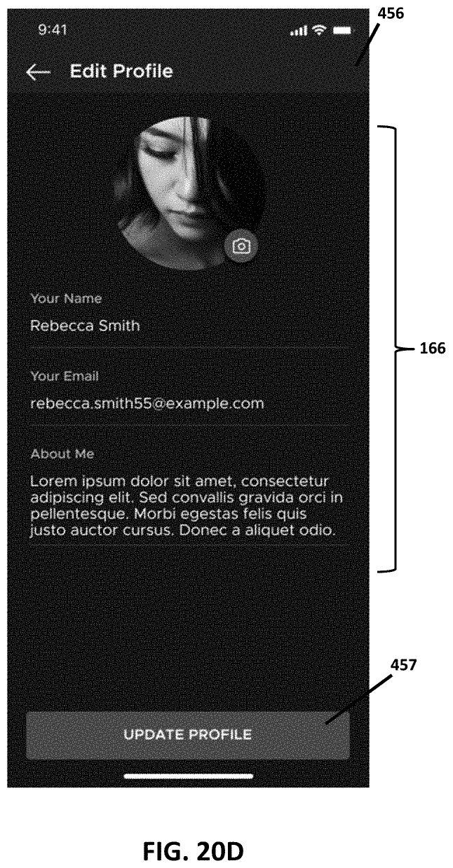

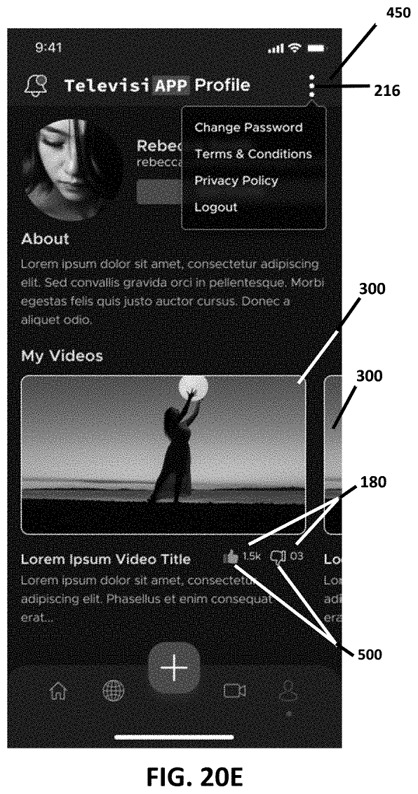

After uploading at least one Snippet to the Snippet library, the Owner User can have access to an Owner User Dashboard interface screen 450, examples of which are shown in FIGS. 20A-20E. An Owner User Dashboard interface screen can include at least a listing, textual and/or graphic, of the one or more Snippets 175 the Owner user submitted to the Snippet library 170. Additional information specific to each Snippet can also be included on the Owner User Dashboard interface screen, such as, by way of example, the current vote Tallies 180 for the Snippet can be provided, the title, the description or a portion thereof, and other information provided by the Owner User. The Owner User Dashboard can also include personal identifying information that the Owner User provided when creating a App User profile 166 on the Profile Interface Screen 164, discussed above. FIG. 20A shows a screen shot of an embodiment of an Owner User Dashboard that show just a listing of the Owner User's uploaded Snippets. FIGS. 20B and 20C show screen shots of embodiments of an Owner User Dashboard that includes personal identifying information about the Owner User, as well as a listing of the Owner Snippets 300, associated with the App User Profile, which can be scrolled vertically (FIG. 20B) or horizontally (FIG. 20C). In another embodiment, the Owner User Dashboard can include a Edit Profile button 454 that displays an Edit Profile interface screen 456, an example, of which, is shown in FIG. 20D. The Edit Profile interface screen displays the identifying information input fields 161 and allows an App User to edit personal information therein, which is associated with the App User Profile 1660. Selecting an Update Profile button 457 updates the personal information displayed on the Owner User Dashboard.

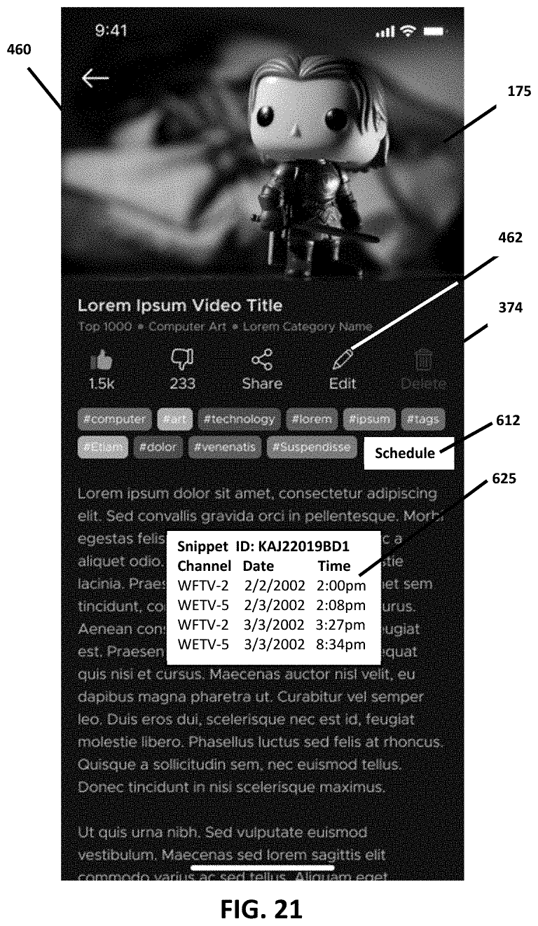

In one embodiment, the Owner User can select one of the Snippets from the Owner User Dashboard to show an Owner Snippet interface screen 460, which is similar to the Snippet Interface screen 230, but can include additional functions available to the Owner User, such as, for example, a Delete button 374 and an Edit button 462. FIG. 21 shows one example of an Owner Snippet interface screen. The Delete button can be similar to the one on the Add Details interface screen 360, but can be used after an Owner Snippet 300 has been uploaded to the Snippet library. In one embodiment, a Warning Screen 376 will be shown whenever the Delete button is clicked regarding a Snippet.

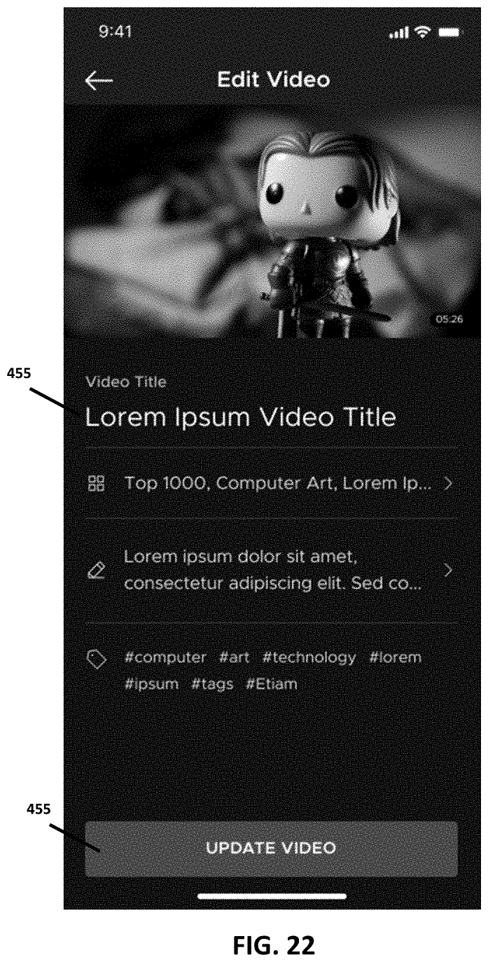

The Edit button 462 on the Owner Snippet interface screen 460 can be used to navigate to an Edit Snippet interface screen 455, one example of which is shown in FIG. 22. The Edit Snippet interface screen can provide buttons similar to those on the Add Details interface screen 360, but are used to edit the Snippet identifying information 325 associated with an Owner Snippet 300 that has been added to the Snippet library 170 by the Owner User. In one embodiment, the Edit Snippet interface screen shows at least a portion of the current identifying information associated with each button, so, for example, the Owner User can see a portion of one or more of the title, the description, and/or the tags that are associated with the Snippet 175 in the Snippet library. An Update button 452 can be used to save the changes.

Once a Snippet 175 is in the Snippet library 170, the CIMS will associate at least one Vote button 500 with the Snippet. App Users viewing the Snippet can utilize the Vote button to provide an opinion on the Snippet. In one embodiment, each Snippet has at least one Vote button available on the Snippet List interface screen 220, an example of which is shown in FIG. 9. This can allow App Users to vote on a Snippet without navigating to the specific Snippet interface screen 230, In another embodiment, at least one Vote button is also available on the Snippet interface screen 230, so an App User can vote either before or after viewing the Snippet on the Snippet interface screen. One example of this embodiment is shown in FIG. 10A.

There are a variety of opinions that App Users can have regarding a Snippet. The most basic opinion would be whether the App User “liked” or “disliked” the Snippet. In one embodiment, two Vote buttons 500 are provided for each Snippet for an App User to select whether they liked or disliked the Snippet, such as shown in FIG. 10A, Snippets in certain categories can have other types of opinions and vote therefore. Thus, Snippets can have vote buttons that allow an App User to provide a more granular opinion. By way of non-limiting example, a Snippet can include vote buttons for liking and disliking, as well as buttons to express whether the Snippet was “funny,” or “informative,” “artistic,” “sad,” or “boring.”

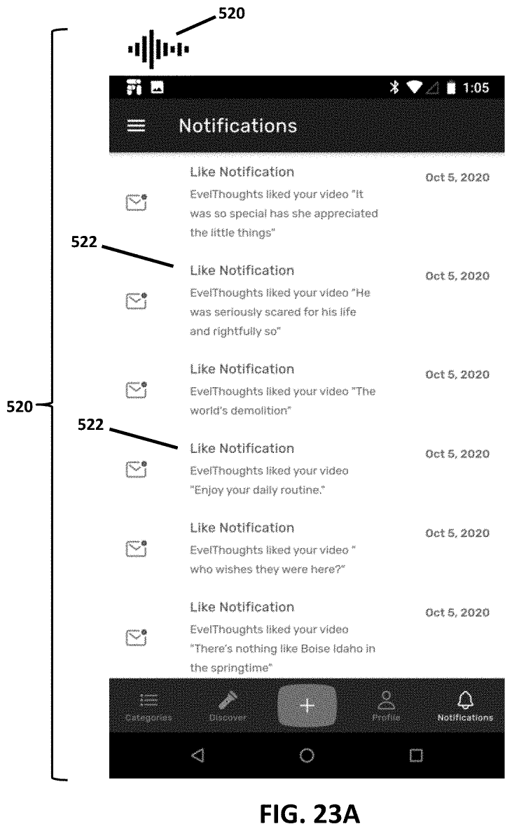

It can be beneficial to provide an Owner User with one or more notifications pertaining to the one or more Snippets 300 that were submitted by the Owner User to the Snippet library. Notifications can provide feedback for example, about which Snippets were popular, which categories of Snippets were most voted on, and other information. One important aspect of providing notifications can be to provide feedback submitted by other App users regarding a Snippet. In one embodiment, the Mobile App 155 provides Owner Users that submit Snippets with an option for selecting a “push notification” 520 regarding each of the Snippets the Owner User has submitted to the Snippet library 170. In a specific embodiment, the Owner User can select the type of push notification to receive. For example, each time a Snippet of the Owner User is opened or received on a client device, or each time a vote is received by the Snippet of the Owner User, the Mobile App triggers the client device 130 to emit some detectable audible, visual, or haptic signal such as sound, graphic on the client device, or a vibration. Owner Users can have the option of selecting a detectable indication to be emitted. In another example, shown in FIG. 23A, the Owner User can select to a text-based notification 522 for each vote received for a Snippet. A text-based notification can include information such as, for example, a comment about the Snippet from an App User, a description of an action that the App User took regarding the Snippet, e.g., voted, Shared, or reported, and the date and time the vote was cast. In one embodiment, the text-based notification can include personal identifying information that the App User provided on the Profile Screen 164 when Registering or, if they are also an Owner User, personal identifying information on their Owner User Dashboard 450, For example, the text-based push notification can include an App User's profile picture and name or an Owner App's name, profile picture, Snippet listing, and other information on the Owner User Dashboard. In another embodiment, the push notification can include a link 524 to access the Profile information about the App User or Owner User that voted. FIG. 23B shows an example of a Profile screen 458 that appears on the Push Notification listing by selecting the link.

In one embodiment, a push notification is sent to the Owner User each time a. Snippet is viewed. In another embodiment, a push notification is sent each time a Snippet receives a vote. In a specific embodiment, the Owner User can select which type of votes result in a push notification. In a specific embodiment, the Owner User can select to receive a push notification when a Snippet is moved to the Trending Category 190. As discussed below, Snippets that advance to the Trending Category can be used for a network broadcast. In a specific embodiment, an Owner User can receive one or more push notifications pertaining to the network broadcast.

Each vote can increase the number in the Tally total 180 shown next to each Vote button, an example of which is shown in FIGS. 9, 10A, and 20A-20E. Each vote can also be transmitted to the CIMS, which can maintain a Tally 510 of each vote received for each Snippet. The Vote Tally 510 for a Snippet can be used by the CIMS to calculate Rank 550 for the Snippet relative to other Snippets within a Category 172 or relative to the entire Snippet Library 170. The server system 100 can collate the Snippets based on the Tally of each Snippet. In one embodiment, the collated list of Snippets is arranged numerically and the position on the collated list corresponds to the Snippet Rank. A Rank can be, for example, first, second, third, etc. on the collated list. In a further embodiment, Snippets with the same number of votes and, thus, the same Tally receive the same rank. As will be described below, Snippets having a specific Rank can be considered a Trending Snippet 195.

The CIMS can include an algorithm for performing Vote Tally analyses to determine the Rank of each Snippet. In one embodiment, the CIMS can calculate the Snippet Ranks 550 periodically and can change the Rank of Snippets accordingly. In one embodiment, the CIMS can conduct calculations once a week. In another embodiment, the CIMS can conduct calculations every 2, 3, 4, 5 or 6 days. In one embodiment, the CIMS can conduct calculations at least once in each 24-hour period. In another embodiment, the CIMS can conduct a calculation two or more times in each 24-hour period. In one embodiment, after periodic calculations are performed by the CIMS, the composition of the Trending Category 190 can change, as a result.

Each time the CIMS conducts a calculation to determine the Rank 550 of each Snippet, the CIMS can also select a pre-determined number of snippets. Snippets have a Rank high enough to be eligible for placement in a different Category reserved for those Snippets that acquire a sufficient number of votes, which is referred to herein, for literary convenience, as a Trending Category 190. In one embodiment, the Trending Category is shown as the first or top-most Category on the Home interface screen 200. FIG. 8A shows an example of a Home page with a Trending Category at the top of the client device display. App Users can select the Trending Category 190 to view a Snippet listing interface screen 220 that includes the Snippets that have received the highest Ranks 550 which are Trending Snippets 195. In one embodiment, the Trending Category is limited to a pre-determined or set number of Trending Snippets, say, for example, the Top 1000 Trending Snippets. In an alternative embodiment, the Trending Category contains all Trending Snippets that achieved a minimum Rank or above, such as, for example, any Snippet that has a minimum of 2000 up-votes.

A Trending Snippet 195 that obtains a Trending Snippet position within the Trending Category can give the Owner User that submitted the Snippet a sense of achievement. In one embodiment, the Owner User can receive a special push notification 520 that is different from other push notifications when their Trending Snippet achieves a position in the Trending Category 190. Embodiments of the subject invention can advantageously provide App Users with Snippets in the Trending Category 190 with additional recognition by using the Snippets for a television broadcast.

Television broadcasts often have breaks during shows or programs in which short messages are provided to viewers, often in the form of paid-for commercials, public interest messages, public announcements, and other short presentations. Snippets 175 are preferably short in length, and preferably less than a minute, more preferably about 10 seconds to about 15 seconds in length. This can make Snippets ideal for presentation during program breaks and for filling in short air times between other messages. Furthermore, presenting or “airing” Snippets during program breaks can encourage viewers to watch the program in anticipation of seeing one or more Snippets.

In one embodiment. Trending Snippets 195 that have achieved a position in the Trending Category 190 can be relayed, transmitted, sent, provided on a computer readable medium, such as a CD, flash drive, or other physical device, or otherwise made available to a broadcast network 600. The broadcast network can arrange one or more of the Trending Snippets 195 into lengths of “air-time” that fit somewhere within or fills one or more program breaks. The broadcast network can also review the Trending Snippets for compliance with Federal Communications Commission (FCC) rules and regulations for network broadcasts.

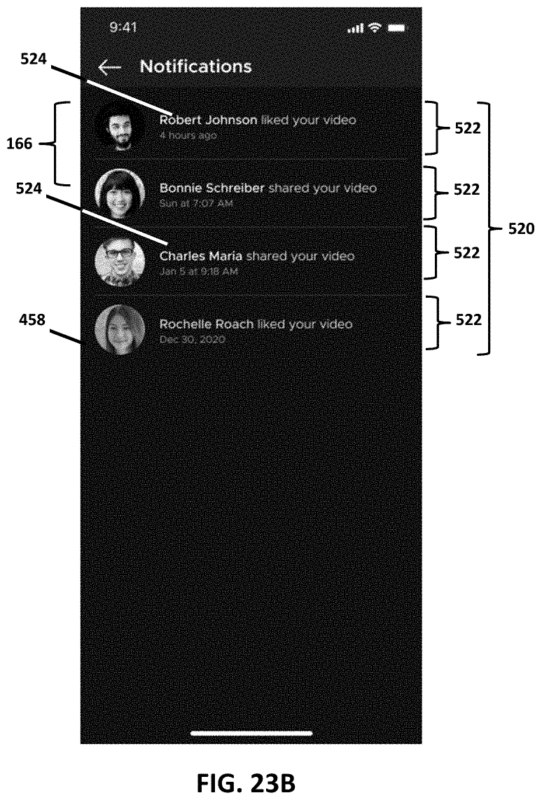

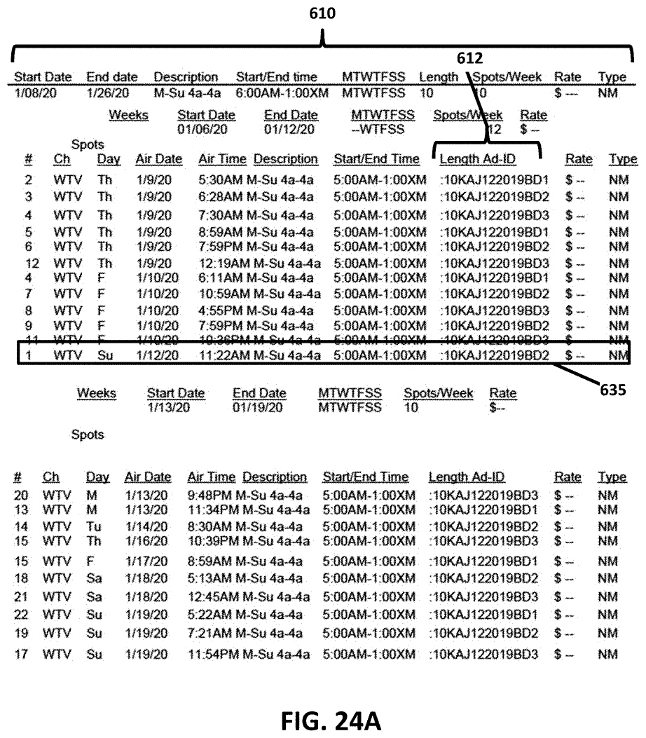

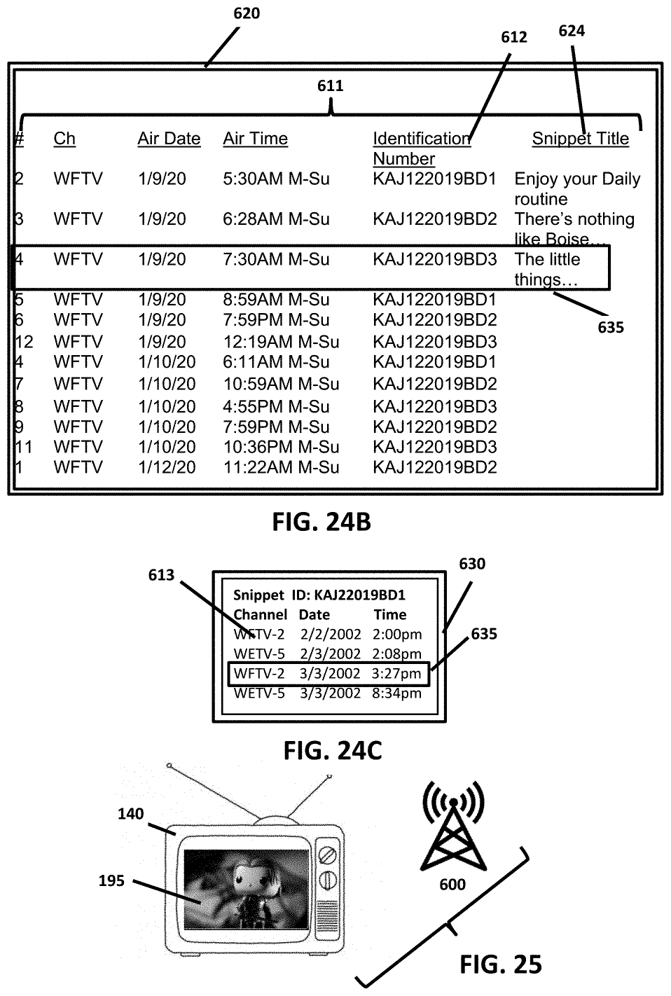

In one embodiment, the broadcast network 600 can create a Schedule 610 that lists at least the date and time each Trending Snippet 195 will be broadcast, but can include other information, such as, for example, costs associated with purchasing the air time, the length of each Trending Snippet, and an Identification number 612 unique to each Trending Snippet. FIG. 24A shows an example of a broadcast Schedule 610 generated by a broadcast network. In one embodiment, the agreed upon Broadcast Schedule 610 is relayed, transmitted, sent, or otherwise made available to the CIMS 150 on the server system 100.

Upon receipt of the Broadcast Schedule 610, the CIMS can present the broadcast schedule to an App User of the Mobile App 155. This is advantageous because it allows the App User of the Mobile App to plan to watch one or more Trending Snippets during the scheduled program break. This can be advantageous for the broadcast network as it can encourage App Users to watch particular programs in anticipation of seeing one or more Trending Snippets 195 during the program break. It is well-known that programs with large audiences generate higher commercial revenue for both the network broadcaster that sells “airtime” and to the commercial entities that buy the air-time to increase their sales and revenue.

Different broadcast networks can provide Broadcast Schedules 610 in different formats and with different information, some of which may not be relevant to App Users. Depending on the Broadcast Schedule format received from a broadcast network, it can be necessary for the CIMS or the Administrator thereof, to modify the Broadcast Schedule for presentation to App Users. In one embodiment, a portion of the information on the Broadcast Schedule is provided to App Users as a Modified Broadcast Schedule. In one embodiment, a Modified Broadcast Schedule 611, such as shown, for example, in FIG. 24B, can include at least the network call letters and channel on which a Trending Snippet 195 will be broadcast. A Modified Broadcast Schedule can also include the dates and air-times for a Trending Snippet 195. In one embodiment, the Snippet Title 224 is provided on the Modified Broadcast Schedule, along with the Identification Number 612. In a further embodiment, the Modified Broadcast Schedule is searchable, so that, for example, App Users can search the Modified Broadcast Schedule. In yet another embodiment, the Modified Broadcast Schedule is printable through the Mobile App.

In one embodiment, the Modified Broadcast Schedule 611 is provided to App Users on a Schedule Interface Screen 620, one example of which is shown in FIG. 24B. In a further embodiment, an App User can navigate to the Schedule Interface Screen with a Schedule Button 612 that can be provided on any of the screens of the Mobile App. It can be most beneficial, but not required, to include the Schedule Button on a Mobile App screen on which the Trending Snippets in the Trending Category 190 are also available. FIG. 9 illustrates an example of Schedule Button 612 provided on a Snippet Listing Interface Screen 220 for the Trending Snippets. FIG. 21 shows an example of a Schedule Button provided on a Snippet Interface Screen 460, such as would be available for a Trending Snippet.

In one embodiment, the Modified Broadcast Schedule 611 includes broadcast information for every Snippet 175. For example, the Modified Broadcast Schedule can be provided on the Schedule Interface Screen 620 screen, such that App Users can scroll through or search to see when each Snippet will be broadcast. In a particular embodiment, when an App User selects the Schedule Button 612 when on a Snippet Listing Screen 220, the Modified Broadcast Schedule is provided. In an alternative embodiment, App Users can be provided with a Snippet Broadcast Schedule 613 that is a further modified Broadcast Schedule 610 comprising the information pertaining to a specific Trending Snippet 195. For example, FIG. 21 shows a Snippet. Broadcast Schedule that includes the channel number, network call letters, date, and air-time relevant to the selected Trending Snippet 195. In one embodiment, when the Schedule Button 612 is used, the Snippet Broadcast Schedule can appear as a Snippet Broadcast Schedule Overlay screen 625, such as shown, for example, in FIG. 21. Alternatively, the Schedule Button can be used to navigate to a Snippet Broadcast Schedule Interface Screen 630, such as shown, for example, in FIG. 24C. In a particular embodiment, an App User on a Snippet interface Screen 230 selects the Schedule Button to access the Snippet Broadcast Schedule.

Since Trending Snippets 195 can be aired several times during a daily broadcast schedule, an App User may find it helpful to receive reminders when one or more Trending Snippets are going to be aired. It can also be beneficial if at least one of the Broadcast Schedule 610, Modified Broadcast Schedule 611, and Snippet Broadcast Schedule 613 are interactive, such that the App User can use one of the schedules to configure Broadcast Reminders 650. In one embodiment, an App User can request to receive a reminder from the Mobile App 155 when a Trending Snippet will be aired. Broadcast Reminders can be similar to Push Notifications, which have been discussed above. In one embodiment, each Trending Snippet entry 635 on at least one of the Broadcast Schedule, Modified Broadcast Schedule, and Snippet Broadcast Schedule can be used to configure a reminder to an App User. FIGS. 24A, 24B, and 24C show example of Trending Snippet Entries 635 on each type of schedule. By selecting the Trending Snippet Entry, the App User can arrange for or set-up a Broadcast Reminder 650 to be sent to the client device 130 at a specified time prior to the air-time for that particular entry. Broadcast Reminders can be visible, audible, haptic, or some combination thereof that are generated by the client device when prompted or signaled by the mobile app. FIG. 1 shows an example of a Broadcast Reminder.

In one embodiment, both Push Notification 520 and Broadcast Reminder 650 preferences can be pre-set within the Mobile App. In a further embodiment, a Push Notification/Reminders Button 700 can be provided for accessing the available preferences. FIG. 20A shows an example of a Push Notification/Reminder Button that can be available on the App User Dashboard Interface Screen 450 and used to display a Preferences Screen 710, such as shown, for example in FIG. 20F, on which App User preferences can be selected. As with the schedules mentioned above, the Preferences Screen can be an overlay screen or a separate screen that is navigated to with the Push Notification/Reminder Button. Push notifications and Broadcast Reminders can keep App Users engaged even when not actively watching Snippets or uploading Snippets on the Mobile App.

Internet content and television programs have for the most part maintained a separate existence. While internet content has witnessed a significant increase in viewership, due in no small part to the increase in mobile telephone usage, television programing has seen reductions in viewership. While television programming is available through internet access, there is considerably less internet content available on network television. The computer-implemented method and system (CIMS) disclosed herein advantageously bridges the gap between internet content and television programming. Snippets obtained through the internet with a Mobile Application can be formatted to be beneficial to television programming. Furthermore, by providing push notifications, voting options, and a competitive environment where Snippets can be advanced to a special Category, App Users of the Mobile Application are encouraged to participate and to provide high quality internet content in the form of Snippets. App Users are rewarded for their efforts by having their Snippets shown to a wider audience through television broadcasting.

All patents, patent applications, provisional applications, and other publications referred to or cited herein are incorporated by reference in their entirety, including all figures and tables, to the extent they are not inconsistent with the explicit teachings of this specification. Additionally, the entire contents of the references cited within the references cited herein are also entirely incorporated by reference.

Any reference in this specification to “one embodiment,” “an embodiment,” “example embodiment,” “further embodiment,” “alternative embodiment,” etc., is for literary convenience. The implication is that any particular feature, structure, or characteristic described in connection with such an embodiment is included in at least one embodiment of the invention. The appearance of such phrases in various places in the specification does not necessarily refer to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

I claim:

1. Method and system for utilizing curated internet-based multimedia content as a television broadcast, the method and system comprising:
providing to at least one client device one or more multimedia content;
receiving from the at least one client device a vote pertaining to the one or more multimedia content;
determining the one or more multimedia content receiving a number of votes to qualify the one or more multimedia content as trending multimedia content;
providing to a broadcast network the one or more trending multi-media content; and
receiving a broadcast schedule from the broadcast network pertaining to the network broadcast of the one or more trending multimedia content.

2. The method and system according to claim 1, wherein the one or more multi-media content comprises a one or more snippet within a Snippet library.

3. The method and system according to claim 2, wherein the one or more snippet has a run-time of one minute or less.

4. The method and system according to claim 3, wherein the one or more snippet has a run-time of at least 10 seconds, at least 15 seconds, at least 20 seconds, at least 25 seconds, at least 30 seconds, at least 35 seconds, and a least 40 seconds.

5. The method and system according to claim 4, wherein the broadcast network schedules the network broadcast of the one or more trending snippets during a program break.

6. The method and system according to claim 2, wherein the client device utilizes a mobile application to receive the one or more snippet and present the one or more snippet to an App User.

7. The method and system according to claim 6, wherein the App User utilizes the mobile application to provide the vote on the Snippet.

8. The method and system according to claim 7, further comprising the App user utilizing the mobile application to set-up one or more Broadcast Reminders.

9. The method and system according to claim 8, wherein the broadcast schedule is a modified broadcast schedule.

10. The method and system according to claim 9, wherein the Modified Broadcast schedule provides network broadcast information for a specific Snippet.

11. The method and system according to claim 10, further comprising sending a push notification to the Owner User pertaining to the Snippet.

12. A computer-implemented method embodied on one or more computer readable medium comprising instructions executable by a processor, the computer implemented method comprising instructions for:
providing one or more snippets from a Snippet Library, to at least one client device;
receiving from the at least one client device a vote pertaining to the one or more snippets;
calculating a tally for the one or more snippets;
utilizing the tally to determining the one or more snippets that qualify for inclusion in a Trending Category;
providing to a broadcast network the one or more snippets included in the Trending Category;
receiving from the broadcast network a broadcast schedule pertaining to a network broadcast of the one or more snippets included in the Trending category; and
providing at least a portion of the broadcast schedule to the client device.

13. The computer-implemented method according to claim 12, further comprising a mobile application downloadable to the at least one client device and by which the one or more snippets is provided to the at least one client device.

14. The computer-implemented method according to claim 13, further comprising receiving from the mobile application a vote pertaining to the one or more snippets.

15. The computer-implemented method according to claim 13, further comprising providing the at least a portion of the broadcast schedule to the client device through the mobile application.

16. The computer-implemented method according to claim 12, wherein the at least a portion of the broadcast schedule is a Modified Broadcast Schedule provided through the mobile application.

17. The computer-implemented method according to claim 16, further comprising providing to the client device one or more Broadcast reminders.

18. The computer-implemented method according to claim 14, further comprising receiving one or more Owner Snippets into the Snippet Library.

19. The computer-implemented method according to claim 18, further comprising transmitting a push notification when the Owner Snippet is viewed by an App user.

20. The computer-implemented method according to claim 19, wherein the mobile application further comprises an Add Details Interface Screen for including information regarding the Owner Snippet prior to inclusion in the Snippet library.
